(19) United States
(12) Patent Application Publication
(10) Pub. No.: US 2004/0158502 A1
(43) Pub. Date: Aug. 12, 2004

(54) Method and apparatus for a selling service

(75) Inventors: Randall C. Adams, Menlo Park, CA (US); Andrew D. Jeffrey, Menlo Park, CA (US)

Correspondence Address: MICHAEL B. EINSCHLAG, ESQ., 25680 FERNHILL DRIVE, LOS ALTOS HILLS, CA, 94024, US

(73) Assignee: AuctionDrop, Inc., San Carlos, CA

(21) Appl. No.: 10/764,002

(22) Filed: Jan. 23, 2004

Related U.S. Application Data
(60) Provisional application No. 60/442,595, filed on Jan. 24, 2003.

(51) Int. Cl. G06F 17/60

(52) U.S. Cl. 705/26

(57) ABSTRACT

One embodiment of the present invention is a selling service that includes: (a) accepting items to be sold from sellers; (b) generating data regarding the items; (c) formulating listings for the items; (d) transmitting the listings to a marketplace; and (e) providing items purchased in the marketplace.

This application claims the benefit of U.S. Provisional Application No. 60/442,595, filed on Jan. 24, 2003, which is incorporated herein by reference.

### TECHNICAL FIELD OF THE INVENTION

One or more embodiments of the present invention pertain to a method and/or apparatus for a selling service.

### BACKGROUND OF THE INVENTION

Many sellers have items to sell for which there are no local buyers, or for which there is a particular audience of buyers that is difficult to reach. Additionally, many sellers may desire to access a larger potential market than is readily available to such sellers locally. Many marketplaces offer solutions to one or more of these problems, however many such marketplaces require a complex set of steps and requirements in order to sell an item. Online marketplaces are an example of one such solution. In particular, large auction sites such as eBay® offer millions of items for sale worldwide to many potential buyers by enabling sellers to post electronic listings for items. Unfortunately, the process of creating a high quality listing for an item may require significant work which may include many complex steps.

Carrying out a series of complex steps to utilize an online marketplace may be objectionable to a seller, and as a result, this creates a barrier to many sellers. Thus, items which could be sold utilizing online marketplaces are either stored needlessly, thrown out, or sold at garage sales for prices below what buyers in an online marketplace might pay.

In light of the above, there is a need for the method and/or apparatus for a selling service that solves one or more of the above-described problems.

### SUMMARY OF THE INVENTION

Advantageously, one or more embodiments of the present invention, solve one or more of the above identified problems. In particular, one embodiment of the present invention is a selling service that comprises: (a) accepting items to be sold from sellers; (b) generating data regarding the items; (c) formulating listings for the items; (d) transmitting the listings to a marketplace; and (e) providing items purchased in the marketplace.

### BRIEF DESCRIPTION OF THE DRAWING

FIG. 1 shows a flow of items through a Selling Service in accordance with one or more embodiments of the present invention;

FIG. 2 shows a Selling Service Plant Layout and Item Flow that is fabricated in accordance with one or more embodiments of the present invention;

FIG. 3 shows a Selling Service Compute Infrastructure apparatus that is fabricated in accordance with one or more embodiments of the present invention;

FIG. 4 shows a flow of items through a Selling Service arranged in a “Spoke and Hub” configuration in accordance with one or more embodiments of the present invention;

FIG. 5 shows a flow-chart of steps performed at a Selling Service Inlet in accordance with one or more embodiments of the present invention;

FIG. 6 shows a flow-chart of steps performed at a Selling Service Hub in accordance with one or more embodiments of the present invention;

FIG. 7 shows a flow-chart of steps performed to process a Listing at a Selling Service Hub in accordance with one or more embodiments of the present invention;

FIG. 8 shows a flow-chart of a multiplicity of Store, Display, and Pack steps that can be performed at a Selling Service Hub in accordance with one or more embodiments of the present invention;

FIG. 9 shows a Data Entry User Interface that is fabricated in accordance with one or more embodiments of the present invention;

FIG. 10 shows a User Interface used by an Inlet operator to record Container ID(s) for item containers that is fabricated in accordance with one or more embodiments of the present invention;

FIG. 11 shows a Gatekeeper User Interface that is fabricated in accordance with one or more embodiments of the present invention;

FIG. 12 shows a typical manifest that is fabricated in accordance with one or more embodiments of the present invention;

FIG. 13 shows a Weighing User Interface that is fabricated in accordance with one or more embodiments of the present invention;

FIG. 14 shows an Item Testing User Interface that is fabricated in accordance with one or more embodiments of the present invention;

FIG. 15 shows a PhotoStation User Interface that is fabricated in accordance with one or more embodiments of the present invention;

FIG. 16 shows a Listing Generation Edit-View User Interface that is fabricated in accordance with one or more embodiments of the present invention;

FIG. 17 shows a Listing Generation Images-View User Interface that is fabricated in accordance with one or more embodiments of the present invention;

FIG. 18 shows a portion of a Listing Generation Preview-View User Interface that is fabricated in accordance with one or more embodiments of the present invention;

FIG. 19 shows a portion of a Listing Generation Preview-View User Interface that is fabricated in accordance with one or more embodiments of the present invention;

FIG. 20 shows a portion of a Listing Generation Preview-View User Interface that is fabricated in accordance with one or more embodiments of the present invention;

FIG. 21 shows a portion of a Listing Generation Preview-View User Interface that is fabricated in accordance with one or more embodiments of the present invention;

FIG. 22 shows a portion of a Listing Generation Preview-View User Interface that is fabricated in accordance with one or more embodiments of the present invention;

FIG. 23 shows a portion of a Listing Generation Preview-View User Interface that is fabricated in accordance with one or more embodiments of the present invention;

FIG. 24 shows a Container Location User Interface that is fabricated in accordance with one or more embodiments of the present invention;

FIG. 25 shows a Customer Checkout User Interface that is fabricated in accordance with one or more embodiments of the present invention;

FIG. 26 shows a Customer Confirm Purchase User Interface that is fabricated in accordance with one or more embodiments of the present invention;

FIG. 27 shows a PayPal® Payment Confirmation Page that is fabricated in accordance with one or more embodiments of the present invention;

FIG. 28 shows a Customer Credit Card Purchase User Interface that is fabricated in accordance with one or more embodiments of the present invention;

FIG. 29 shows a Customer Confirm Credit Card Purchase User Interface that is fabricated in accordance with one or more embodiments of the present invention;

FIG. 30 shows a Pick Station User Interface that is fabricated in accordance with one or more embodiments of the present invention;

FIG. 31 shows a Pack User Interface that is fabricated in accordance with one or more embodiments of the present invention; and

FIG. 32 shows a Ship It User Interface that is fabricated in accordance with one or more embodiments of the present invention.

### DETAILED DESCRIPTION

The following terms have the following meanings in the description that follows:

Selling Service Compute Infrastructure: a collection of computer and network equipment, data output devices (such as for example, and without limitation, printers), data entry devices (such as, for example, and without limitation, keyboard, mouse, bar-code scanner, and magnetic strip readers), algorithms, and all software used at a Selling Service (defined below).

Selling Service: a collection of one or more of a Selling Service Compute Infrastructure, employees, users, facilities, equipment, processes, and methodologies that are used to implement a system of accepting items for sale at Inlets, tracking, processing, inspecting, possibly testing, listing, managing inquiries about, storing, tracking, and notifying seller and buyers of the status of the item in a Marketplace, for example, and without limitation, eBay, shipping, delivering, and/or allowing the pickup of the products sold to buyers and compensating a Seller.

Selling Service Processing: a collection of processes from ingress to egress that occur during the time an item is present, tracked, or anticipated in a Selling Service in accordance with one or more embodiments of the present invention.

Seller: an individual or entity with something (for example, and without limitation, an item and/or service) to sell who elects to utilize a Selling Service for selling an item and/or service to a buyer.

Buyer: an individual or entity that purchases something (for example, and without limitation, an item and/or service) from a Marketplace, or a print advertisement, or a similar market or various form of auction.

Marketplace: in the broadest sense, an online site, an interactive gathering (using, for example and without limitation, communication technology), or a physical location, where items are bought and sold, for example and without limitation, in the case of an auction: an auction, a telephone auction, silent auction, a Dutch auction, reverse auction, straight auction, sealed auction, fixed price, with or without Buy It Now (BIN) option.

Inlet: any location or facility where items flow into a Selling Service to be processed. In accordance with one or more embodiments of the present invention, an Inlet may comprise any one of a number of different types of facilities, for example without limitation, a stand alone-dedicated store, a location (such as a counter or terminal) within a larger store (such as a grocery store or discount store), a location within a larger building, a truck, car, or other mobile vehicle that can be used as temporary points of drop-off at different locations (such as a Seller's home or place of employment), a ship-to location, or a Seller's home or place of employment. In the case of corporate use, the location could include a partition or portion of a building, a terminal in a shipping and receiving department, and the like. An Inlet may be a location in or near a Hub. This might be the case when a single shipment or delivery of items from an entity, for example and without limitation, a pallet of goods from a manufacturer, is delivered. In accordance with one or more embodiments of the present invention, some processing of an item may occur at the location of the item's ingress into the Selling Service Process flow.

Inlet Apparatus: a collection of one or more apparatus used to perform one or more Inlet Processes.

Inlet Processes: a collection of one or more processes performed at an Inlet.

Hub: a location at which items obtained from one or more Inlets are processed. This location may or may not be located in geographically distinct regions from Inlets. In the most general terms, a Hub is a location, for example, and without limitation, a central location at which disparate items obtained from one or more Inlets are processed by the Selling Service.

Hub Processes: a collection of one or more processes performed at a Hub.

Data Store: in accordance with one or more embodiments of the present invention, one or more relational databases (for example and without limitation, databases supporting SQL) are used to store, retrieve, and manipulate data within the scope of an n-tier software system. Such one or more databases may be comprised of software running on a central machine or distributed among machines and/or locations and may or may not reside at a corporate headquarters, one or more Hubs, and/or equipment provided by one or more third-party hosting services. In addition, such one or more databases may be implemented using any one of a number of commercially available databases, for example, without limitation, a relational database offered by Oracle Corporation located at 500 Oracle Parkway, Redwood Shores Calif., 94065; or the SQL Server relational database offered by Microsoft Corporation located at 1 Microsoft Way, Redmond, Wash. 98052. Alternatively, other database systems, such as, for example and without limitation, MySQL and Postgres are available in the public domain under various licensing terms.

Information Transport Layer: a collection of hardware, software, physical networks, and protocols used to transport information from one electronic device to another. In accordance with one or more embodiments of the present invention, a transport layer may comprise, for example and without limitation: the Internet, a dedicated network such as an Ethernet local area network (LAN) and/or a Wide Area Network (WAN), a secure Virtual Private Network (VPN), a dial-up modem, a high-speed Digital Subscriber Line (DSL), computers connected to the Internet which may transfer information between systems using protocols including but not limited to standard protocols such as “Hypertext Transfer Protocol” (http), “Secure hypertext Transfer Protocol” (https), or combinations of the two protocols on a network supporting TCP/IP or other transport protocols. It should be understood that there are many protocols and physical networks that are well known to those of ordinary skill in the art for communicating information between computers and computing devices, such as communicating information via the Wireless Application Protocol (WAP), 802.11a, 802.11b, 802.11g or other message protocols such as IrDA and Bluetooth network. It should also be understood that the manner of communication may vary between software modules, and that multiple protocols and transport methodologies may be employed simultaneously using techniques that are well known to those of ordinary skill in the art. In addition, the “.NET” architecture supports many forms of IP-based communication that may be used to communicate information between software applications running on one or more computers. It should be noted that although one or more embodiments of the present invention use the Internet and HTTP protocol, further embodiments of the present invention are not limited thereto. In particular, there are numerous means well known to those of ordinary skill in art for entering a record in a remote or local database, and numerous processes for synchronizing, buffering and validating data arriving in a database from a remote location. For example, and without limitation, a dial-up modem may be used to transfer information; different protocols may be used to communicate information stored in system databases such as “Secure hypertext Transfer Protocol” (HTTPS), XML, RPC, Web Services, or SOAP, and the data may be encoded, compressed or encrypted before being transmitted. In accordance with one or more embodiments of the present invention, information to be stored, written, updated, inserted, deleted or recorded in a database is transmitted via the Information Transport Layer.

User Interface: a screen or other presentation apparatus used to convey information to a user, edit information, and/or capture information from a user or an operator. Typically, a User Interface is embodied as a computer screen, a keyboard, and a mouse. However, embodiments of the present invention are not thusly limited, and further embodiments may be fabricated wherein an audio interface with speech recognition (which speech recognition is embodied using techniques that are well known to those of ordinary skill in the art) may be used for presenting information and/or capturing spoken input or responses.

Data Entry User Interface (DEUI): a screen or other presentation apparatus at an Inlet used to convey information to an Inlet operator or directly to a Seller; and/or to receive and capture information about a Seller and his/her item(s) in a format that can be edited or altered using an input device (if required). A DEUI may be implemented using Software Modules (as defined below), and may use Client-Side Data Validation (as defined below) and/or server-side data validation.

Read, Check, Select, or Indicate (from Database): Read, Check, or Indicate in the context of a database refer to techniques well known to those of ordinary skill in the art to retrieve information from a database, and possibly present the data in an Internet browser, or a computer program (application), or a viewer for human or machine consumption. There are numerous techniques well known to those of ordinary skill in the art for retrieving information from databases. For example, and without limitation, Microsoft's SQL Server may be accessed using “.NET” software to create web-pages and/or Windows-forms whose contents are dependent on data stored in a database. The web pages used to present data may be static HTML or dynamic HTML created by server-based software such as Microsoft's .NET and/or ASP technologies (as described in the on-line Help Systems of the Microsoft Visual Studio NET development system and the Microsoft “.NET” Framework, Version 1.1; both of which are incorporated by reference herein). For functionality implemented using web-based technologies, the deployment may leverage one or more of the following: servers, databases, integrated applications, database content, webs, load-balancers, and/or load monitoring applications.

Client-Side Data Validation: a process for verifying data on a computer or data terminal. In accordance with one or more embodiments of the present invention, “Active Server Pages” (ASP) in the Microsoft “.NET” architecture deployed as web-based HTTP are used to verify data on the client machine before it is submitted to the server.

Software Modules: computer program code for performing operations of one or more embodiments of the present invention that may be written, for example and without limitation, in an object oriented programming language such as JAVA, C#, C++, and/or Visual Basic. Such computer program code may also be written in conventional procedural programming or scripting languages, such as “C”, JavaScript, TSQL (and/or database stored procedures), Perl, or in a functional (or fourth generation) programming language such as Lisp, SML, or Forth. In addition, Microsoft Active Server Pages (ASP) and “.NET” Framework components such as: Windows-Form and Web-Form technology; and Java Server Pages (JSP) technology may also be utilized. The computer program code may execute entirely on one or more Web servers and/or application servers, or it may execute partly on one or more Web servers and/or application servers and partly on a remote computer (i.e., a user's Web client), or as a proxy server at an intermediate point in the network. In the latter scenario, the remote computer may be connected to the Web server using any one of a number of means that are well known to those of ordinary skill in the art, for example and without limitation, a LAN or a WAN (e.g., an intranet), or the connection may be made through the Internet (e.g., via an Internet Service Provider).

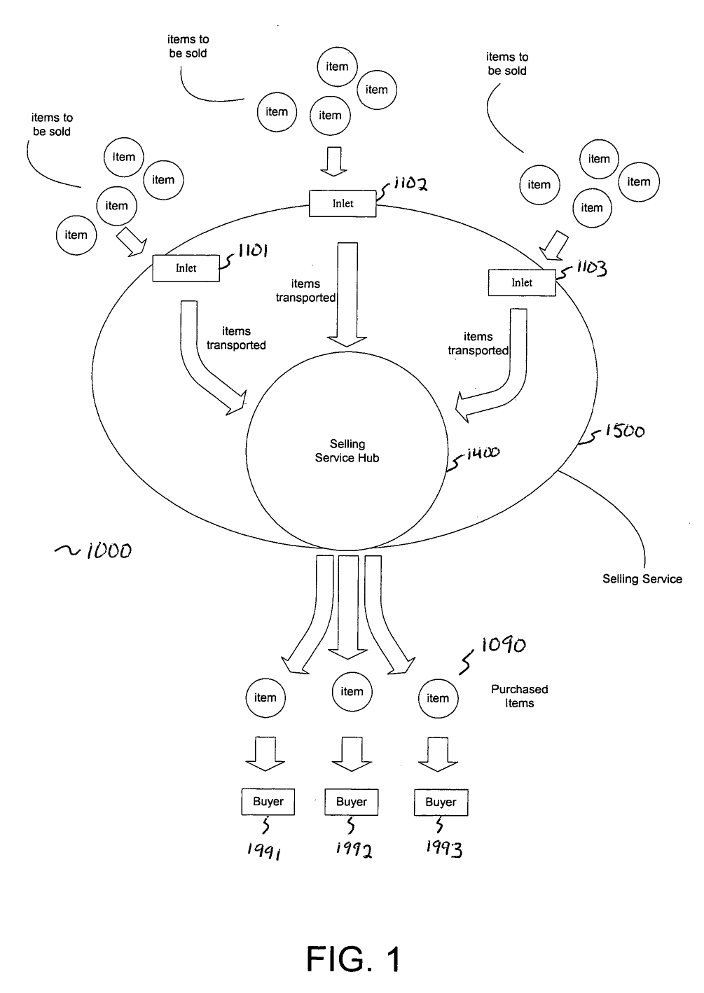

Overview of Process Flow Through a Selling Service: FIG. 1 shows an overview of process flow in Selling Service 1500 that is fabricated in accordance with one or more embodiments of the present invention. As shown in FIG. 1, items enter Selling Service 1500 through one of several Inlets: Inlet 1101; Inlet 1102; and Inlet 1103. As further shown in FIG. 1, a group of items to be sold enter Inlet 1101 and are transported to Selling Service Hub 1400. In a similar manner, other items to be sold are dropped off at Inlet 1102 and transported to Selling Service Hub 1400, and so forth. For ease of understanding, only three Inlets are show in FIG. 1, however it should be understood that in accordance with one or more embodiments of the present invention, a multiplicity of Inlets may be employed. Selling Service Hub 1400 performs a number of steps which will be explained in further detail below, and creates one or more “offers to sell” for the items it receives. For ease of understanding, only a typical case of items being sold is shown in FIG. 1. When items are purchased, Purchased Items 1090 are shipped to the buyers, for example, Buyer 1991; Buyer 1992; and Buyer 1993.

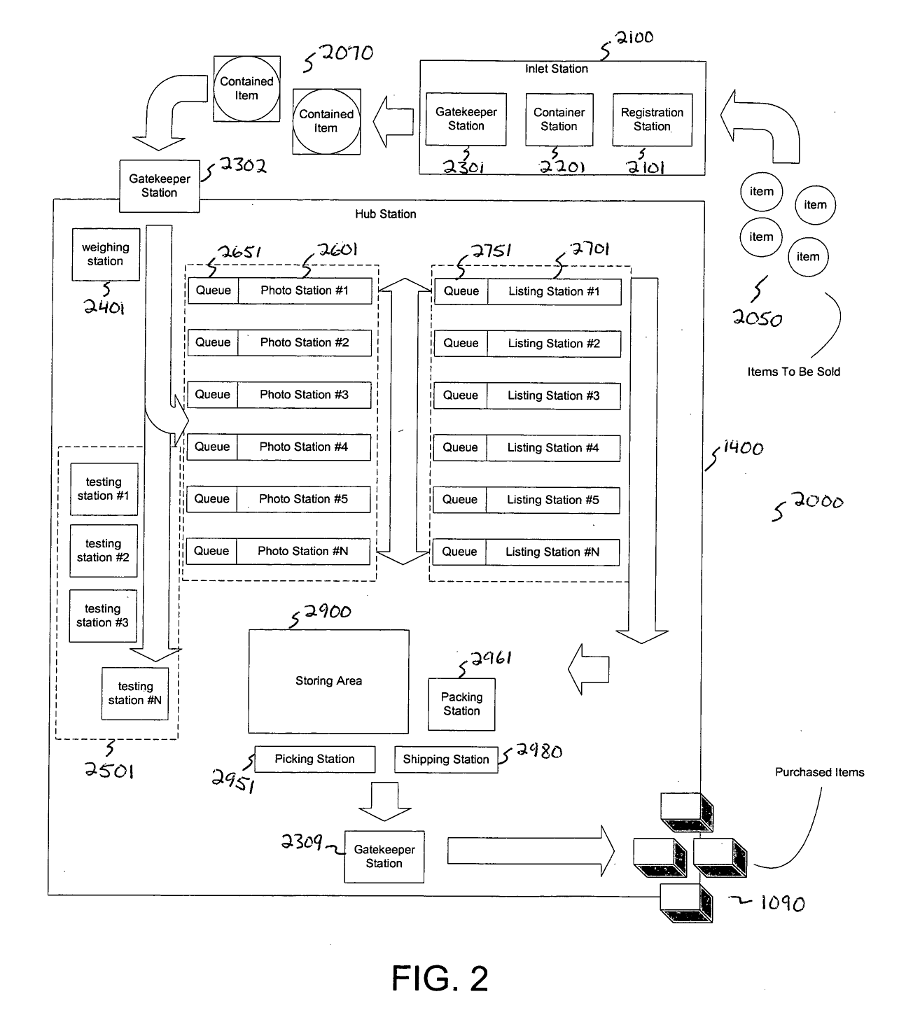

Selling Service Plant Layout and Item Flow: FIG. 2 shows Selling Service Plant Layout and Item Flow 2000 that is fabricated in accordance with one or more embodiments of the present invention. As shown in FIG. 2, for a typical scenario, items 2050 that will be offered for sale are input to Selling Service Plant Layout and Item Flow 2000, and Selling Service Plant Layout and Item Flow 2000 produces, as one output, items 1090 that have been packed for shipment.

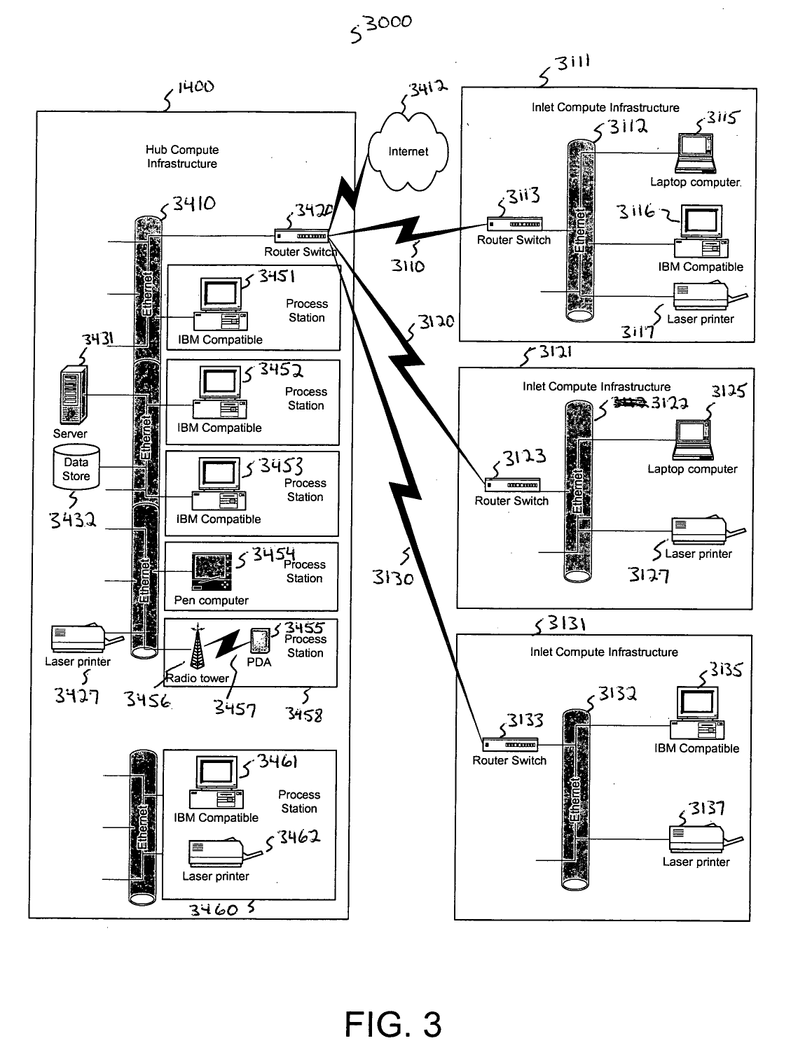

As further shown in FIG. 2, Inlet Station 2100 accepts, as input, items 2050 that are to be sold, and produces, as one output, Contained Items 2070 (a Contained Item is an item in a container). Inlet Station 2100 comprises Registration Station 2101, Container Station 2201, and Gatekeeper Station 2301. It should be understood that the various processing stations described in conjunction with FIG. 2 are locations at which processes are performed using associated apparatus. In accordance with one or more embodiments of the present invention, various software applications execute on substantially similar computing apparatus, referred to as a Process Station, which Process Station will be described in detail below in conjunction with FIG. 3.

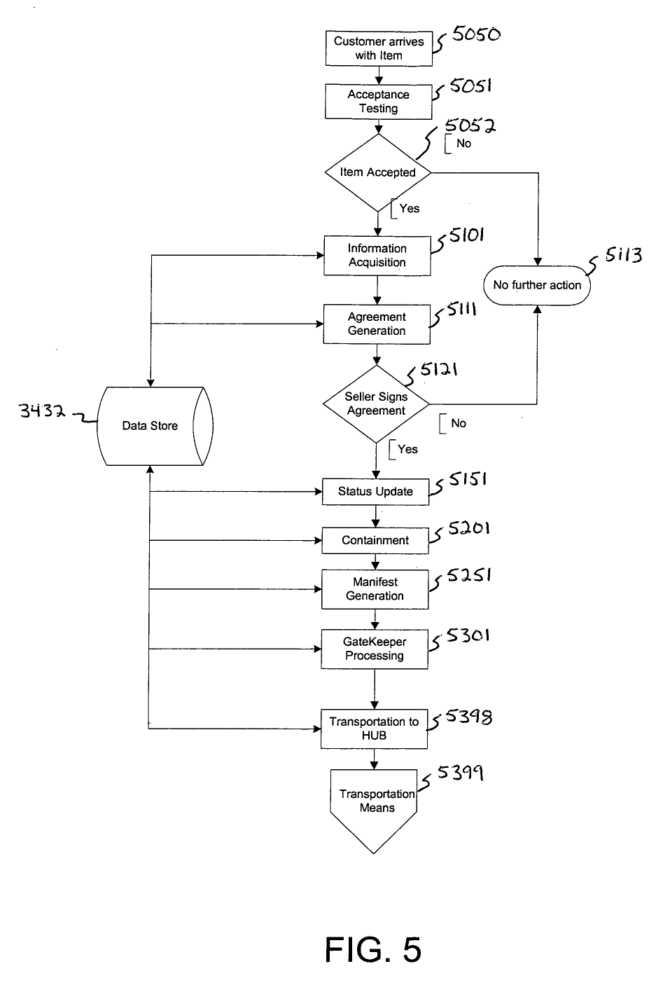

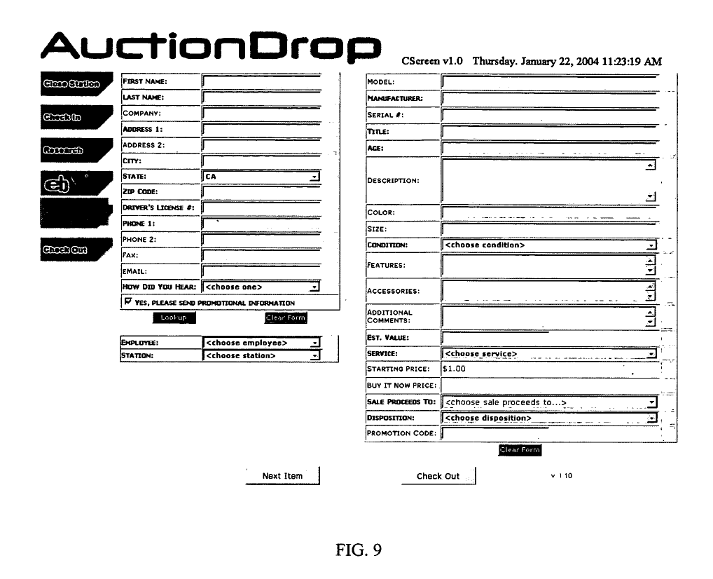

Registration Station 2101 shown in FIG. 2 is a location at which items 2050 are accepted or rejected, and data entry, possible testing, agreement generation, and registration of an item and its Seller is carried out using a registration apparatus. In accordance with one or more embodiments of the present invention, the registration apparatus comprises a Process Station (executing software) that presents a Data Entry User Interface (shown in FIG. 9) and performs the following processes (shown in FIG. 5 and described in detail below): Acceptance Testing 5051, Item Accepted 5052, Information Acquisition 5101, Agreement Generation 5111, Seller Signs Agreement 5121, and Status Update 5151.

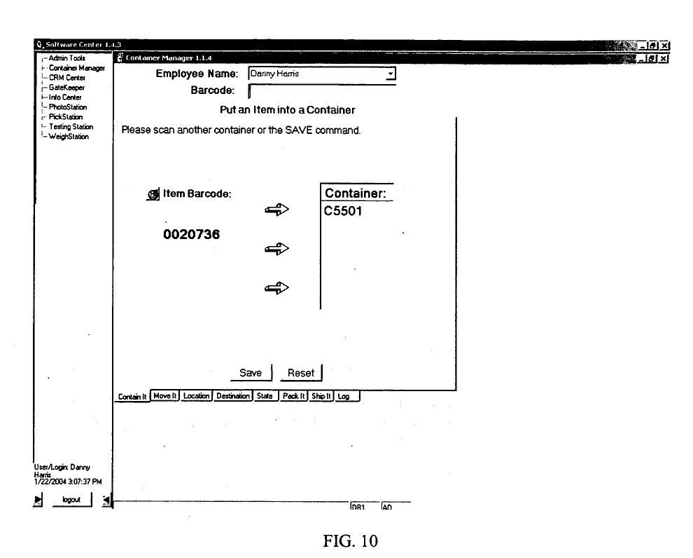

Container Station 2201 shown in FIG. 2 is a location at which items transferred from Registration Station 2101 are accepted using a container station apparatus, and placed in containers. In accordance with one or more embodiments of the present invention, the container station apparatus comprises a Process Station (executing software) that presents a Container User Interface (shown in FIG. 10) and performs the following process (shown in FIG. 5 and described in detail below): Containment 5201.

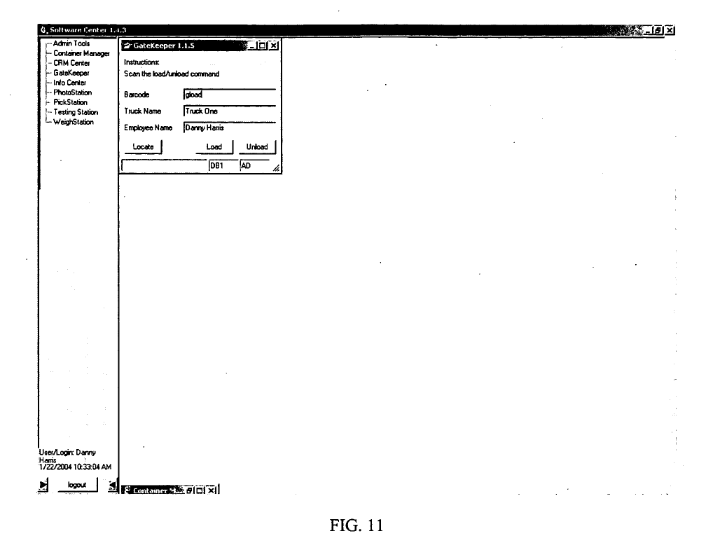

Gatekeeper Station 2301 shown in FIG. 2 is a location at which the following steps are carried out using a gatekeeper load apparatus: (a) a manifest is generated; (b) items are compared with the manifest; (c) the destination of each Contained Item 2070 that is to leave Inlet Station 2100 is compared with a destination of a transport means that will transport the items; and (d) an item's change in location is stored in a database (i.e., Data Store 3432 shown in FG. 3). In accordance with one or more embodiments of the present invention, the gatekeeper load apparatus comprises a Process Station (executing software) that presents a Gatekeeper Login User Interface (shown in FIG. 11) and performs the following processes (shown in FIG. 5 and described in detail below): Manifest Generation 5251 and Gatekeeper Processing 5301.

Next, as shown in FIG. 2, Contained Items 2070 are transported from Gatekeeper Station 2301 within Inlet 2100 to Gatekeeper Station 2302 within Selling Service Hub 1400.

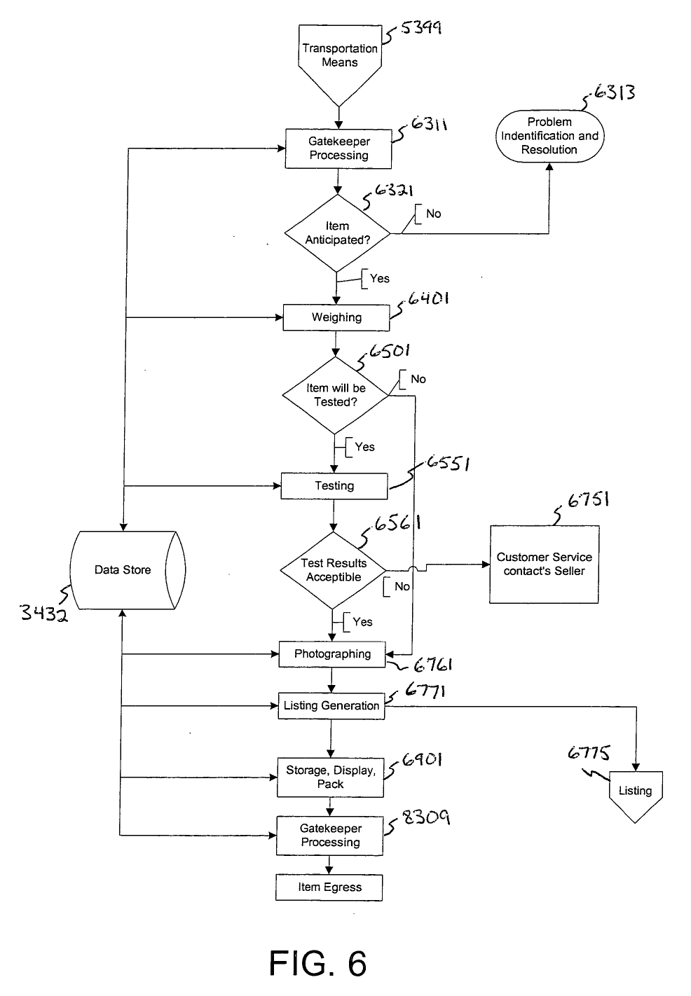

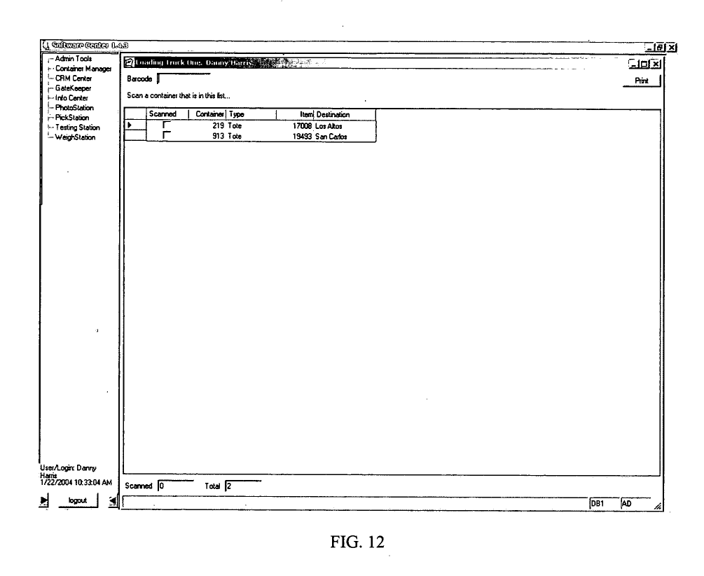

Gatekeeper Station 2302 shown in FIG. 2 is a location within Selling Service Hub 1400 at which, using a gatekeeper unload apparatus, Contained Items 2070 are verified to determine whether each of them is expected, and their change of location is noted in Data Store 3432. In accordance with one or more embodiments of the present invention, the gatekeeper unload apparatus comprises a Process Station (executing software) that presents a Gatekeeper User Interface (shown in FIGS. 11 and 12) and performs the following processes (shown in FIG. 6 and described in detail below): Gatekeeper Process 6311, Item Anticipated 6321, and reports Contained Item 2070 location change in Data Store 3432.

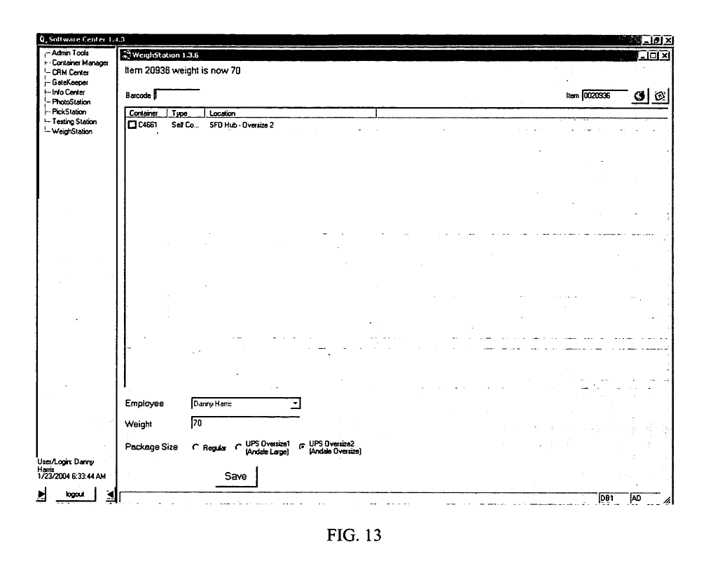

Weighing Station 2401 shown in FIG. 2 is a location within Selling Service Hub 1400 at which Contained Items 2070 are weighted and each item's weight is recorded in Data Store 3432 using a weighing apparatus. In accordance with one or more embodiments of the present invention, the weighing apparatus comprises a scale and a Process Station (executing software) which present a Weighing User Interface (shown in FIG. 13) and performs the following processes (shown in FIG. 6 and described in detail below): Weighing 6401 process and storing weight data in Data Store 3432. In accordance with one or more embodiments of the present invention, the Process Station receives data directly from a scale using techniques that are well known to those of ordinary skill in the art.

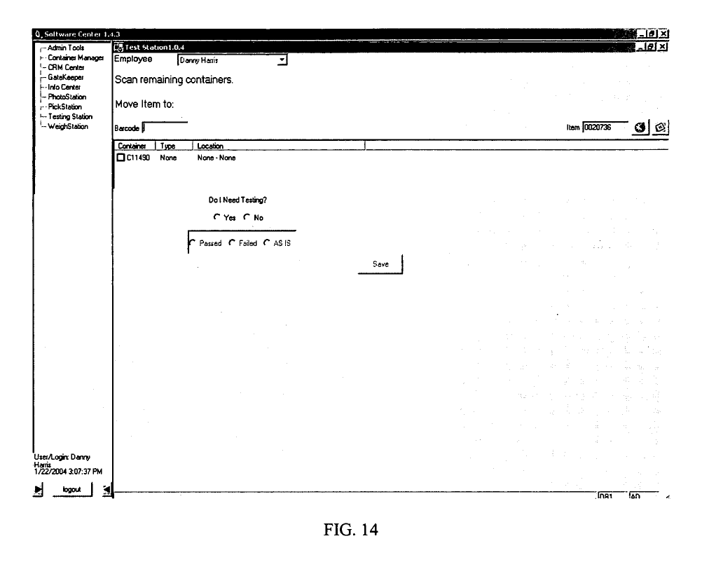

Testing Station 2501 shown in FIG. 2 is a location within Selling Service Hub 1400 at which one or more tests are carried out using one or more instances of a testing apparatus. As shown in FIG. 2, Contained Items 2070 to be tested proceed to one of several testing stations: testing station #1; testing station #2; testing station #3; or testing station #N. At a testing station, items may be removed from their containers and specific tests may be performed which are appropriate to each item. Then, the results of the testing are reported and logged. In accordance with one or more embodiments of the present invention, the testing apparatus comprises one or more of the following: (a) a Process Station (executing software) that presents a Testing User Interface (shown in FIG. 14) and performs the following processes (shown in FIG. 6 and described in detail below): Item Will Be Tested 6501, Testing 6551, and Test Results Acceptable 6561; (b) audio equipment for evaluating stereo components; (c) computer equipment for verifying electronic items; (d) a bike rider to evaluate bicycles; (e) amplifiers to test musical instruments such as guitars; and (e) assorted batteries which may be required to power devices. It should be understood that testing stations may exist outside Selling Service Hub 1400, and that testing stations—in or out of Selling Service Hub 1400—may utilize experts or specific machinery to test, evaluate, and/or authenticate items.

Tested items then enter one of one or more Photo Station Queues 2651. Alternatively, Contained Items 2070 that are not to be tested enter one of the one or more Photo Station Queues 2651 directly from Weighing Station 2401.

Queue 2651 shown in FIG. 2 is one or more locations at which Contained Items 2070 are stored to await processing by a particular Photo Station. In accordance with one or more embodiments of the present invention, Queue 2651 may comprise, for example, and without limitation, a conveyor belt, shelves, racks, or bins.

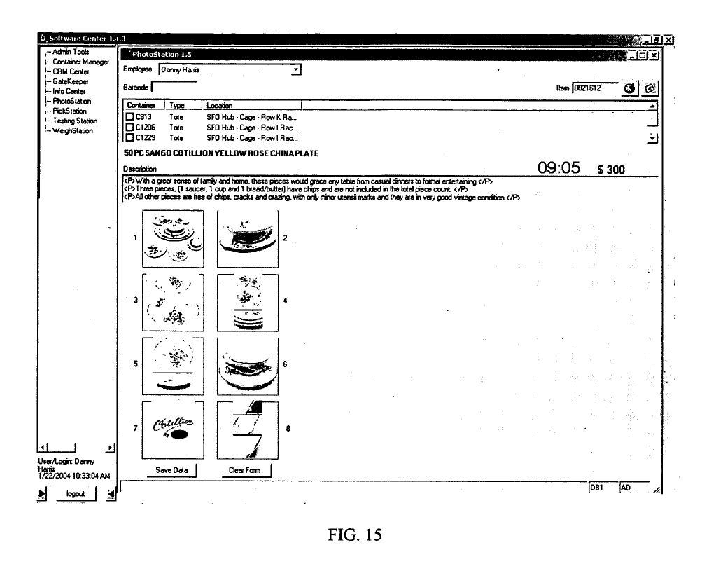

Photo Station 2601 shown in FIG. 2 is one or more locations at which Contained Items 2070 are input from associated portions of Queue 2651. At each of the one or more photo station locations the following steps are carried out using a photo station apparatus: (a) items are removed from their containers; (b) items are photographed to portray the item's strengths and weaknesses (information in the form of Targeted Notes may be utilized to direct the photography); (c) the photographs are stored in Data Store 3432; and (d) the items are then placed back into their respective containers. In accordance with one or more embodiments of the present invention, the photo station apparatus comprises a digital camera connected to a Process Station (executing software) that presents a PhotoStation User Interface (shown in FIG. 15) and performs the following processes (shown in FIG. 6 and described in detail below): Photography 6761.

Contained Items 2070 leaving Photo Station 2601 enter one of the one or more Listing Station Queue 2751 (see the description of Queue 2651 above).

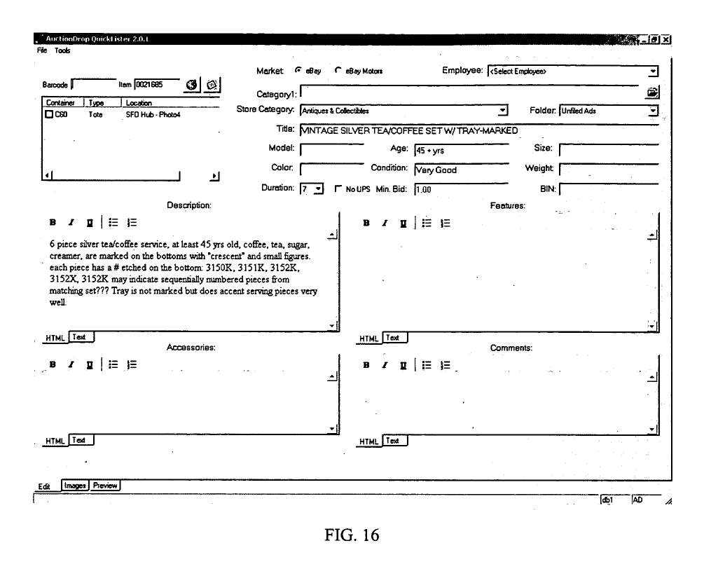

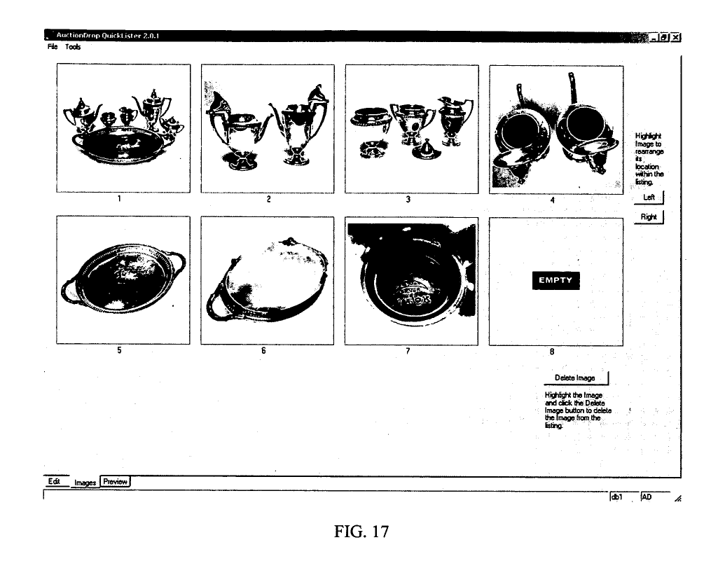

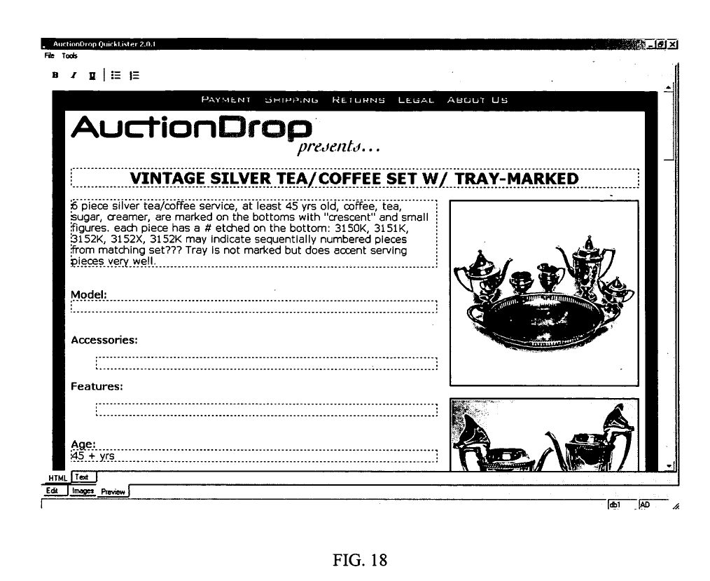

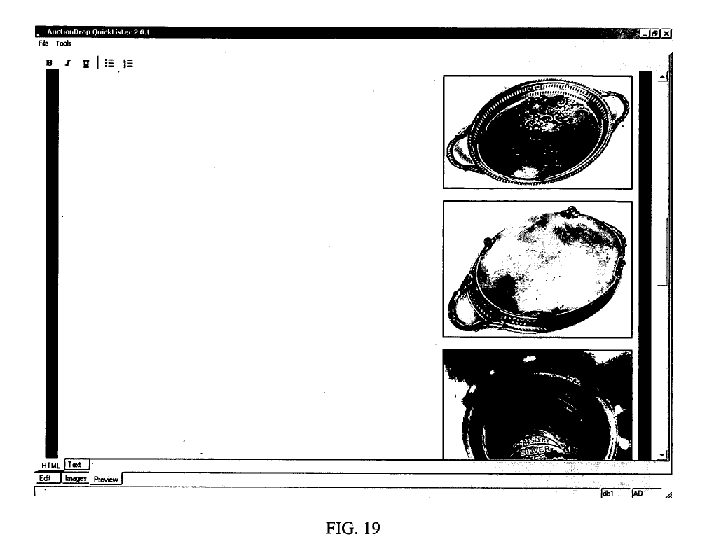

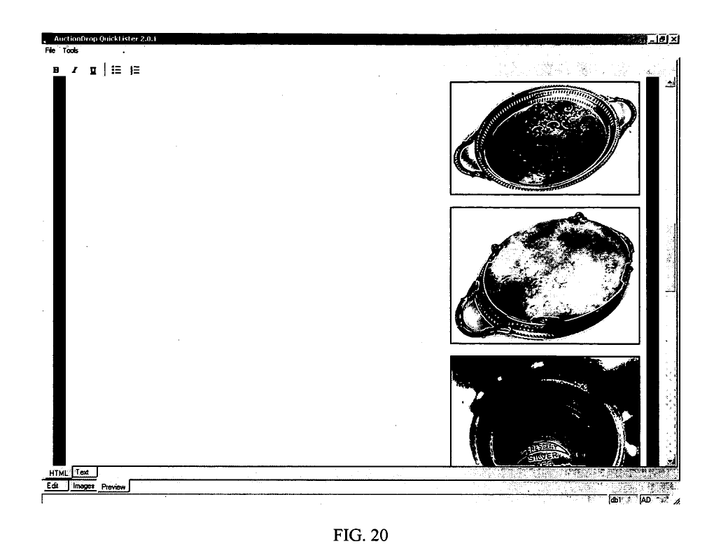

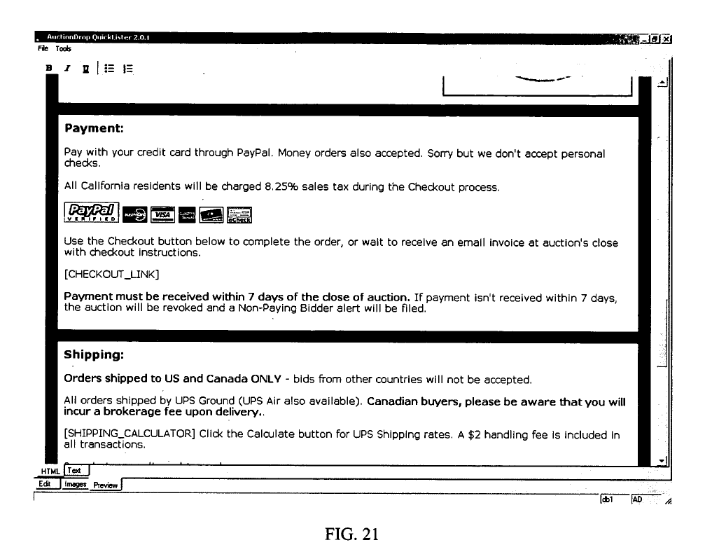

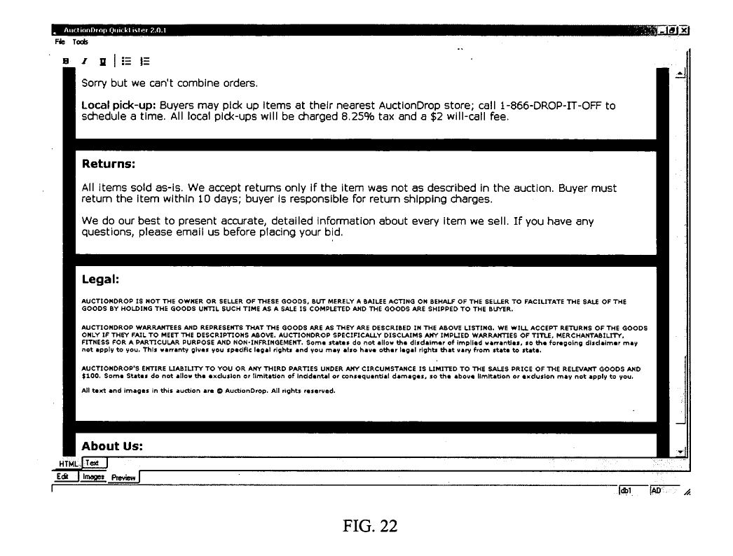

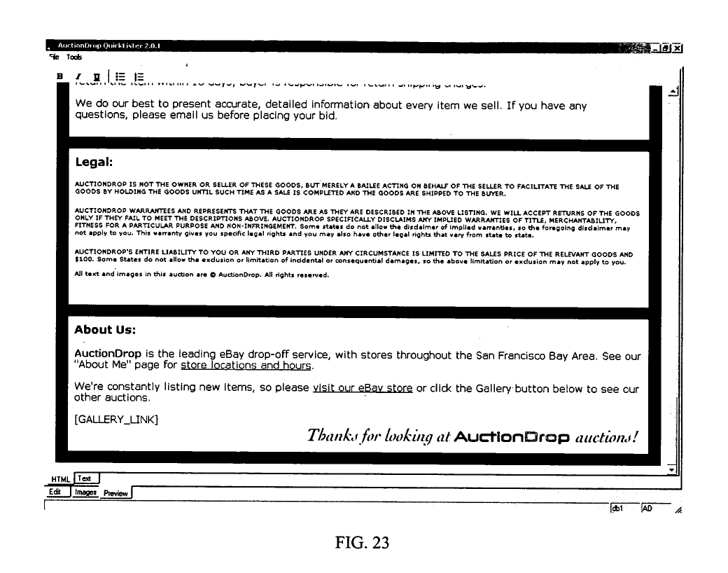

Listing Station 2701 shown in FIG. 2 is one or more locations at which Contained Items 2070 are input from associated portions of Listing Station Queue 2701. At each of the one or more listing stations the following steps are carried out using a listing station apparatus: (a) items are removed from their containers and possibly examined; (b) a written portion of the items' listing may be created or updated—this may include additional information useful to potential buyers (such as for example, and without limitation: shipping weight, shipping terms, item strengths and weaknesses); (c) items' photographs are selected for listing; and (d) a listing is created in Data Store 3432 (information in the form of Targeted Notes may be utilized to direct creation of the listing) wherein the listing comprises photographs, text describing the particular item, and information useful to potential buyers. In accordance with one or more embodiments of the present invention, the listing station apparatus comprises a Process Station (executing software) that presents a multi-tabbed Listing Generation User Interface with the following tabs: Edit-View (shown in FIG. 16); Images-View (shown in FIG. 17); and Preview-View (shown in FIG. 18, FIG. 19, FIG. 20, FIG. 21, FIG. 22, and FIG. 23) and performs the following processes (shown in FIG. 6 and described in detail below): Listing Generation 6771.

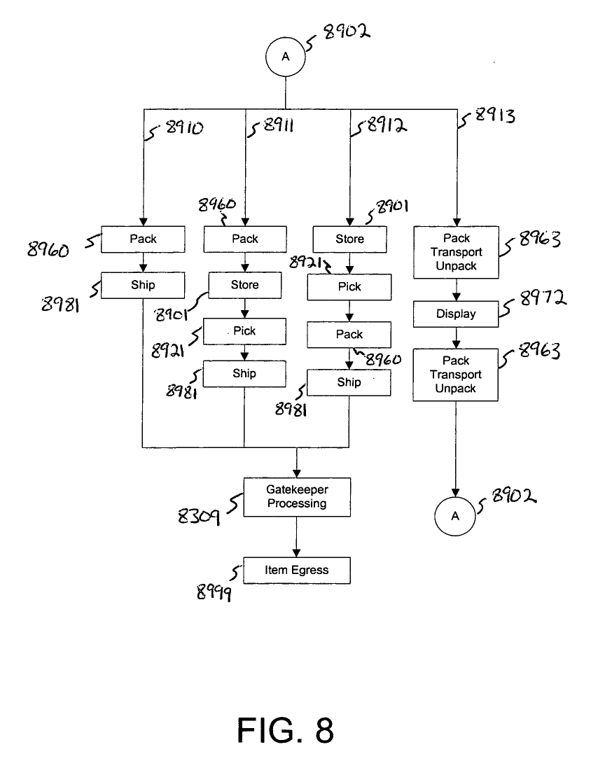

Although several variations are possible, in a typical scenario, Contained Items 2070 which leave Listing Station 2701 proceed to Storing Area 2900. Storage Area 2900 shown in FIG. 2 is a location at which Contained Items 2070 input from Listing Station 2701 are stored (an appropriate location for Contained Items 2070 is selected using a storing area apparatus), the storage locations are stored in Data Store 3432, and the items are retrieved when requested (located using a pick station apparatus to be described below). In accordance with one or more embodiments of the present invention, the storing area apparatus comprises a Process Station (executing software) that performs the following processes (shown in FIG. 8 and described in detail below): Store 8901.

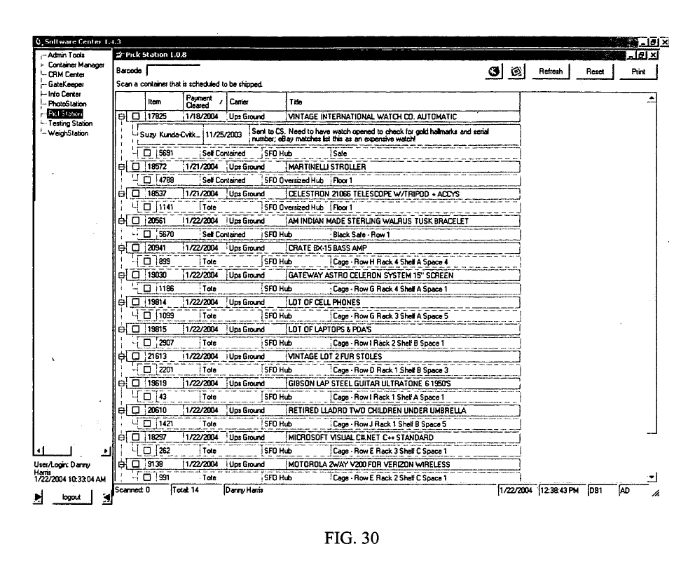

Pick Station 2951 shown in FIG. 2 is a location at which: (a) a list of all items that are to leave Selling Service Hub 1400 is created (along with their location and a description of the item's container), i.e., a list of items available for shipment or pick up, known as a “pick list”; and (b) an item's retrieval is confirmed when items are retrieved. In accordance with one or more embodiments of the present invention, the pick station apparatus comprises a Process Station (executing software) that presents a Pick Station User Interface (shown in FIG. 30) and performs the following processes (shown in FIG. 8 and described in detail below): Pick 8921. In accordance with one or more embodiments of the present invention, the pick station apparatus can also generate a pick list by scanning Data Store 3432 for a list of items eligible for shipment or pickup.

Next, Contained Items 2070 collected are transported to one of: Packing Stations 2961, Shipping Station 2980 or Gatekeeper Station 2309.

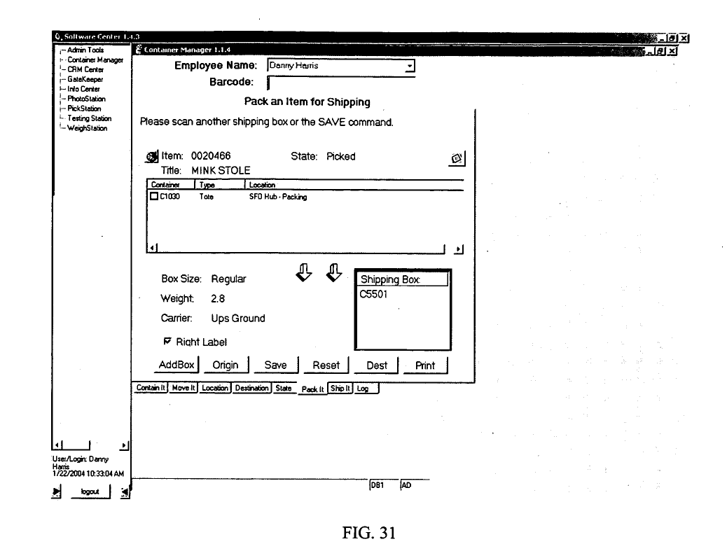

Packing Station 2961 shown in FIG. 2 is one or more locations at which the following steps are carried out for Contained Items 2070 using information about each item and its destination: remove items from their containers; appropriately pack items for shipment; and update information about the packed items new container (for example, and without limitation, a labeled shipping box) using a packing station apparatus. Packing Station 2961 produces as output boxed items which are accepted as input by Shipping Station 2980. In accordance with one or more embodiments of the present invention, the packing station apparatus comprises packing materials, boxes and a Process Station (executing software) that presents a Pack User Interface (shown in FIG. 31) and performs the following processes (shown in FIG. 8 and described in detail below): Pack 8960.

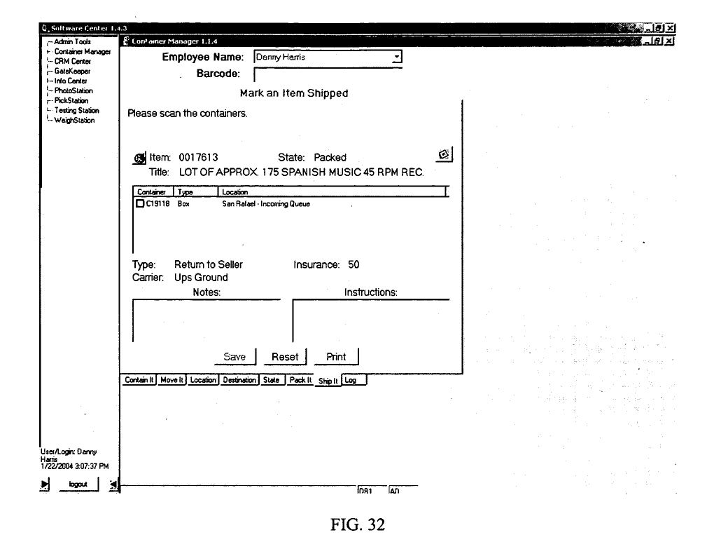

Shipping Station 2980 shown in FIG. 2 is a location at which boxed items are received from Packing Station 2961, Picking Station 2951, or Storage Area 2900 (along with each item's destination from Data Store 3432), and the following steps are carried out using a shipping apparatus: (a) shipping costs are calculated for boxed items using the destination; (b) an appropriate shipping means is determined; and (c) appropriate shipping agents are notified that the boxed items are ready for transport. Shipping Station 2980 produces as one output boxed items, i.e., items 1090, suitable for shipment via shipping means. In accordance with one or more embodiments of the present invention, the shipping apparatus comprises a Process Station (executing software) that presents a Ship It User Interface (shown in FIG. 32) and performs the following processes (shown in FIG. 8 and described in detail below): Ship 8981. Optionally, the shipping apparatus includes a printer that prints labels.

In accordance with one or more embodiments of the present invention, items 1090 are routed to Gatekeeper Station 2309 before egress, and in accordance with one or more further embodiments, items 1090 are shipped or picked up directly from: Shipping Station 2980, Pick Station 2951, Pack Station 2961, or Storage Area 2900. Gatekeeper Station 2309 shown in FIG. 2 is a location at which items 1090 suitable for shipment, a manifest, and information about each item are used to carry out the following steps using a gatekeeper load apparatus: (a) verify that the destination of each boxed item leaving Hub 1400 agrees with the destination of the transport accepting the item; and (b) report the item's location change.

In a typical scenario, boxed items 1090 are transported to their respective Buyers after leaving Gatekeeper Station 2309 within Hub 1400, however, buyers or their agents may pick up the items as described above.

Selling Service Compute Infrastructure Apparatus: FIG. 3 shows Selling Service Computer Infrastructure apparatus 3000 that is fabricated in accordance with one or more embodiments of the present invention. As shown in FIG. 3, a network of a multiplicity of computers is used for accessing data and entering information during the processing of an item. In a typical arrangement, each of the stations described above in conjunction with FIG. 2 uses one or more of the following in the course of processing an item: an IBM Compatible Computer equipped with a keyboard, mouse, monitor, bar-code scanner, a magnetic stripe card reader, and a printer. As further shown in FIG. 3, in the typical arrangement, Selling Service Computer Infrastructure apparatus 3000 contains one or more Inlet Compute Infrastructures: 3111, 3121 and 3131 that share data with a Hub Compute Infrastructure 3400 via respective Communication Links: 3110, 3120, and 3130. For ease of understanding, only three Inlet Compute Infrastructures are show in FIG. 3, however it should be understood that in accordance with one or more embodiments of the present invention, a multiplicity of Inlet Compute Infrastructures may be employed. As shown in FIG. 3, Inlet Compute Infrastructure 3111 contains an Ethernet 3112, Laptop Computer 3115, IBM Compatible Computer 3116, Laser Printer 3117 and Router Switch 3113. Ethernet 3113 acts as a conduit of information for devices connected to it. As further shown in FIG. 3, Ethernet 3112 is connected to Router Switch 3113, Laptop 3115, IBM Compatible Computer 3116, and Laser Printer 3117. Ethernet 3112 provides a means for enabling components connected to it to share data. Router Switch 3113 is connected to Ethernet 3112 and to Communications Link 3110. Router Switch 3113 accepts, as input, data transfers originating within the local area network (LAN) which are destined for networks or devices outside the (LAN). Router Switch 3113 also accepts, as input, data transfers originating outside the (LAN) which are destined for networks or devices within the LAN. It should be understood that Laptop Computer 3115 and IBM Compatible Computer 3116 are standard PCs with various input and output devices to streamline data entry and data output (for example, and without limitation, a keyboard, monitor, mouse, speakers, bar-code scanner, and magnetic strip reader) while running software applications to perform various processes at the Inlet or Process Station. Laser Printer 3117 produces, as output, printed documents, typically one of the outputs is one or more copies of an agreement form for Sellers to sign. It should be understood that in accordance with one or more embodiments of the present invention, the Compute Infrastructure at each Inlet may vary and the software configuration need not be identical across computers within an Inlet or between machines operating at different Inlets. It should also be understood that a single computer may be dedicated to performing a specific task, and that multiple tasks may be performed by one or more computers at an Inlet. Inlet Compute Infrastructure 3121 and Inlet Compute Infrastructure 3131 operate in a manner similar to that of Inlet Compute Infrastructure 3111. As still further shown in FIG. 3, Hub Compute Infrastructure 3400 contains an Ethernet 3410, Internet Access 3412, Server 3431, Data Store 3432, one or more IBM Compatible Computers: 3451, 3452, 3453, and 3455; Pen Computer 3454; Laser Printer 3427, and Router Switch 3420. Router Switch 3420 operates in the same manner as was described for Router Switch 3113. Ethernet 3410 operates in the same manner as was described for Ethernet 3112. Server 3431 runs one or more database programs and software. Software running on Server 3431 processes database transactions and other software requests. Data Store 3432 accepts, as input, data to be stored, requests to store data, and requests to retrieve data. Data Store 3432 produces as two outputs: confirmations of completed requests and data that has been requested. Data Store 3432 may also be used to store database information or to store archival copies of various data. It should be understood that Data Store 3432 may be located within Server 3431 in the form of a disk-array, or Data Store 3432 may exist in a separate location connected via a network to Server 3431. Laser Printer 3427 performs general printing tasks, for example, and without limitation, printing agreement documents, shipping labels, special instructions for items, reports and similar documents used in processing items. Processing Stations 3451, 3452, and 3453 contain substantially identical apparatus to Inlet Compute Infrastructure 3111 and for ease of understanding may be referred to as a Process Station with any appropriate additions, for example, and without limitation it should be understood that a Processing Station with a digital camera refers to apparatus such as IBM Compatible Computer 3116 with the addition of a digital camera connected to it by techniques that are well-known to those of ordinary skill in the art. Pen Computer 3454 is computer which supports the use of a Pen or stylus as an input device rather than a keyboard. Pen computers are used to perform operations for which a typical IBM Compatible Computer would be cumbersome, for example, and without limitation: tasks that require minimal text input, or require the user to be standing or mobile, etc. As still further shown in FIG. 3, means for wireless computer connection may be utilized to communicate data between devices such as PDA 3455 of Process Station #5 3458 using techniques that are well known to those of ordinary skill in the art. As further shown in FIG. 3, Hub Compute Infrastructure 3400 contains one or more IBM Compatible Computers connected to Ethernet 3410 as to manage data associated with the performance of item processing steps. It should be understood that in accordance with one or more embodiments of the present invention, the Compute Infrastructure at each Hub may vary and the software configuration need not be identical across computers within a Hub or between machines operating at within the Hub. It should also be understood that a single computer may be dedicated to performing a specific task, that multiple tasks may be performed by one or more computers at a Hub, and that one or more process stations of the type shown in FIG. 2 may be implemented using a single IBM Compatible Computer. It should also be understood that Internet Access 3412 is utilized to communicate information between Hub Compute Infrastructure 3400 and other entities such as for example, and without limitation, an online Marketplace, an email service, and Inlets.

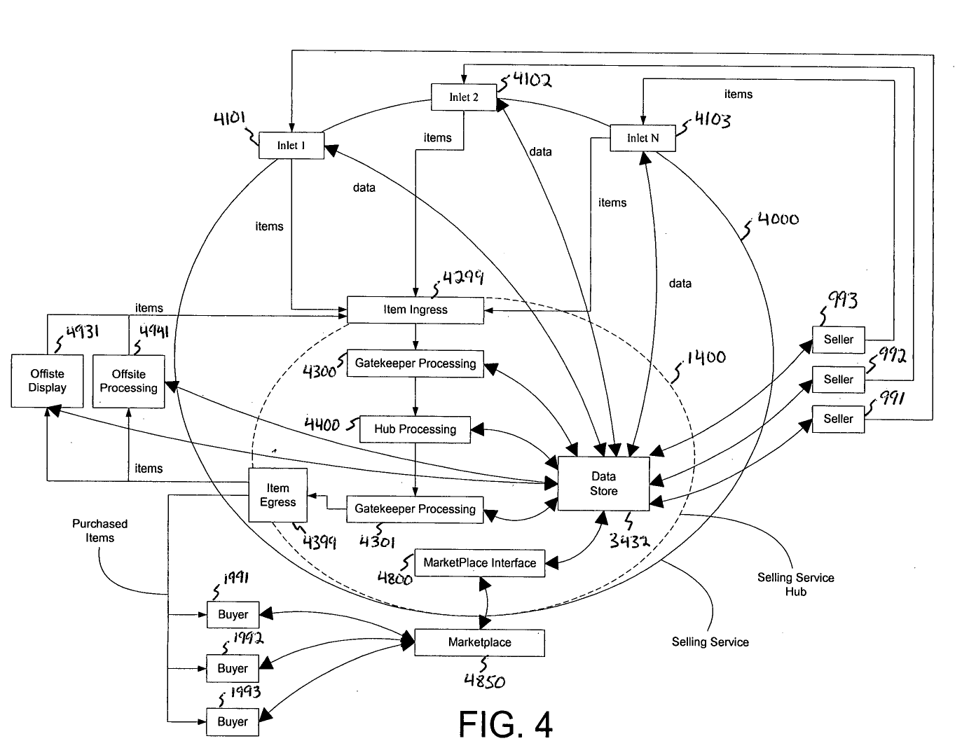

Overview of Process Flow Through a Selling Service that is Arranged in a “Spoke and Hub” Configuration: FIG. 4 shows an overview of process flow in Selling Service 4000 that is arranged in a “Spoke and Hub” configuration in accordance with one or more embodiments of the present invention. As shown in FIG. 4, data communication using Selling Service Compute Infrastructure 3000 (shown in FIG. 3) is displayed pictorially using double ended arced arrows with large arrow heads, and item flow is depicted with straight line single ended arrows. It should be understood that the data communication depicted in FIG. 4 may take place using techniques that are well known to those of ordinary skill in the art for communicating data between computer systems such as, for example, and without limitation, an Information Transport Layer.

As shown in FIG. 4, Selling Service Hub 1400 processes items obtained from one or more of a multiplicity of Inlets, for example, as shown in FIG. 4, Inlet 4101, Inlet 4102 and Inlet 4103. Inlets 4101-4103 accept, as input, items from potential Sellers 991, 992, and 993. In response, Inlets 4101-4103 produce, as output, Contained Items 2070 which have been accepted for sale in Selling Service 4000 and data regarding the items, which data is to be stored in Data Store 3432.

As further shown in FIG. 4, items from Inlets 4101-4103 arrive in containers at Item Ingress 4299 of Selling Service Hub 1400. As was explained previously in conjunction with FIG. 2, Contained Items 2070 proceed through Gatekeeper Processing 4300, and then through various processing steps that are collectively referred to in FIG. 4 as Hub Processing 4400. As further shown in FIG. 4, items leave Selling Service Hub 1400 by proceeding through Gatekeeper Processing 4301, and then through Item Egress 4399. Item Egress 4399 is a departure point for items being transported from Selling Service Hub 1400 to other destinations, for example, and without limitation: points designated by Buyers 1991, 1992, and 1993; Offsite Display 4931, and Offsite Processing 4941. As still further shown in FIG. 4, Marketplace Interface 4800 communicates with Data Store 3432 and Marketplace 4850. In accordance with one or more embodiments of the present invention, Marketplace Interface 4800 performs the following tasks: (i) retrieves data regarding an item from Data Store 3432 of FIG. 3; (ii) processes the item's listing (to be described below); (iii) submits the item's listing to Marketplace 4850; (iv) makes data requests to Marketplace 4850 to determine if the status of the item in the Marketplace (for example, and without limitation: sold, still at auction, expired and the like); (v) performs updates to Data Store 3432. Marketplace 4850 accepts, as input, item listings from Marketplace Interface 4800 and purchasing information such as, for example, and without limitation, offers to buy items, shipping information, and payment information. Marketplace Interface 4800 may produce as some of its outputs: information about the status of an item in the market, purchase price information, shipping methods requested, and payment information.

At each stage of Selling Service 4000, information is collected and stored in a database by one or more computer programs. The system operators enter information using a variety of means that are well known to those of ordinary skill in the art for performing data-entry. In accordance with one or more embodiments of the present invention, labels with barcodes and human readable alphanumeric codes are used to convey information. The information is gathered using handheld scanners, or by entering the alphanumeric codes on a keyboard.

At each stage where a step is performed, information about the operator performing the step, what step was performed, the location at which the step was performed, and the next step and location for an item is recorded in the database using techniques that are well known to those of ordinary skill in the art of relational databases and software engineering. The details of these steps will be disclosed below.

It should be noted that, as shown in FIG. 4, in accordance with one or more embodiments of the present invention, Sellers do not communicate or share data with Buyers or the Marketplace when utilizing Selling Service 4000. It should also be understood that one or more embodiments of the present invention advantageously offer anonymity to a Seller by obviating the need for the Seller to ship items to Buyers or to provide contact information.

Advantageously a “Spoke and Hub” configuration enables Inlets to be located close to Sellers without requiring Hub infrastructure to be needlessly replicated. In addition, it is believed that fully utilizing one Hub serving many spokes (i.e., Inlets) will drive down costs of processing items.

Item Processing at Inlets: The following describes how items are processed at Inlets. In accordance with one or more embodiments of the present invention, items to be sold are accepted at one of one or more Inlets and processed at a Hub. As shown in FIG. 2, Items 2050 arrive at Inlet Station 2100 and are processed at Hub Station 1400. In a typical scenario, Sellers bring items they wish to sell to Inlet Station 2100. In accordance with one or more embodiments of the present invention, Inlet Station 2100 of FIG. 2 contains one or more of the following: an attendant, Inlet Compute Infrastructure 3111 of FIG. 3 (a printer, a magnetic stripe card reader, a barcode scanner, a network connection to Data Store 3432 of FIG. 3), item containers, and packing material.

FIG. 5 shows a flow-chart of the steps performed at a Selling Service Inlet in accordance with one or more embodiments of the present invention, for example, and without limitation, Inlet Station 2100 shown in FIG. 2. As shown in FIG. 5, many process steps read data from and/or write data to Data Store 3432.

In accordance with one or more embodiments of the present invention, the following tasks of Inlet Processing shown in FIG. 5 are performed: Customer Arrival with Item 5050, Acceptance Testing 5051, Item Acceptable 5052 test, Information Acquisition 5101, Agreement Generation 5111, Seller Signs Agreement 5121 test, Status Update 5151, Containment 5201, Manifest Generation 5251, Gatekeeper Processing 5301, and Transportation to Hub 5398. These processes will now be described in greater detail.

Customer Arrival with Item 5050: The process flow begins when a Seller arrives at Registration Station 2101 of an Inlet with an item to sell.

Acceptance Testing 5051: This process is performed at Registration Station 2101 using a registration apparatus (see above). The item is evaluated in light of a list of policies and criteria to determine if the item is acceptable for sale.

Item Accepted 5052: This process is performed at Registration Station 2101 using the registration apparatus. If the item is not accepted, the item is declined and no further action is taken—as indicated by box No Further Action 5113. If the item is determined to be acceptable, the item proceeds to step Information Acquisition 5101.

Information Acquisition 5101: During Information Acquisition 5101, information is collected from the Seller. The information collected may include information necessary to provide payment to the Seller, to contact them in the event an issue arises, and to authenticate the Seller's identity for law enforcement should an issue arise regarding the original ownership of an item. In accordance with one or more embodiments of the present invention, an attendant, for example, a counter attendant, may obtain such necessary information directly from the Seller, the Seller may enter the information directly, or equipment may be used to electronically read it from an identification card (such as a magnetic stripe reader which reads information from a driver's license). This information is captured and relayed to the registration station apparatus. The registration station apparatus presents a Data Entry User Interface (DEUI) that conveys such information to a store clerk or the seller, in a format that can be edited or altered if required. FIG. 9 shows an embodiment of a Data Entry User Interface that is fabricated in accordance with the present invention. As information from a Seller is collected via the card reader or manual entry at a keyboard or other such input device, the information may be communicated to the Data Store 3432 and displayed by a DEUI. Thus, a data dialogue is established in which the DEUI application sends the new information to Software Modules that process and add the information to Data Store 3432. In accordance with one or more embodiments, Software Modules, system databases, and Data Store 3432 respond with additional information such as a list of possible matching names that may be presented to the user of the DEUI to pre-fill information about the Seller such as contact information, preferred method of payment, and the like.

It should be understood that the communication between the Data Store 3432 and the DEUI is accomplished by using the Information Transport Layer. Note that although one or more embodiments utilize a computer and a visual interface, embodiments of the present invention are not thusly limited, and an audio interface with speech recognition or other human-machine interfaces may also be used using techniques that are well known to those of ordinary skill in the art for presenting information and capturing spoken responses. Upon entry and verification of the seller information, the attendant will proceed to enter item(s) datum into the DEUI.

Upon receipt of an item from the Seller, an item is assigned a unique number called an “Item ID.” It should be noted that in accordance with one or more embodiments of the present invention, in cases in which an item is composed of components which can be physically separated, the Item ID refers to the collection of the separated units—provided the units are to be sold as a single entity. For example and without limitation, a Seller may be selling an encyclopedia set composed of twelve books. In this example, the entire set of encyclopedia books is sold as a single item, although the books may be handled and shipped separately as will be described below. Information about the item is stored in a data record in Data Store 3432 and can be edited using the DEUI using means well known to those of ordinary skill in the art.

In accordance with one or more embodiments of the present invention, information about items is entered into the DEUI using one of the following techniques: scanning of the product UPC code from accompanying product packaging, entering the serial number and module numbers from the item itself, entering the ISBN or other unique identification codes (including titles of works) well known to those in the art for specific types of media such as books, videos, DVDs and the like; selecting from a hierarchical system of context sensitive items as will be described.

In accordance with one or more embodiments of the present invention, the user of the system may determine at any point in the process to bypass the context sensitive system and enter all of the information directly into the DEUI. Further, upon activating a button on the DEUI, such as “Accept”, “Next Item”, “Check-Out”, or the like, data validation is performed via one or more software modules operating on the computer on which Data Store 3432 is operating, an intermediary computer, or the computer on which the DEUI is running. The software modules performing the data validation step verify the information is correct before the data is stored in Data Store 3432. This advantageously reduces traffic and load on Data Store 3432. If there is an inconsistency in the data or an incomplete entry, the form is displayed with an indicator of the erroneous entry. In accordance with one or more embodiments of the present invention, red asterisk characters may be displayed besides missing or incorrect entries. If data validation approves the data, this marks the completion of Information Acquisition 5101. Upon completion, the DEUI either resets all screen data in the case where “Check Out” was pressed, or in the case “Next Item” was pressed, the DEUI resets all item specific information keeping the Seller specific information displayed in the DEUI.

One or more embodiments of the present invention make use of a Hierarchical Context Sensitive System when entering information about an item. This system starts with general item category choices, and then, after each choice is made, presents another set of increasingly more specific choices until the precise item is identified. Once identified, the attributes, conditions, accessories, comments, and other information regarding the item can be selected and/or entered into the system. All of this information is then stored into Data Store 3432.

For example, if a user of the DEUI typed or selected “Printers,” the DEUI would then present a list of brands, then model numbers, and finally a list of attributes or characteristics relevant to printers. After selecting the manufacturer, the DEUI would then present a list of model numbers, etc. In general, this type of hierarchical presentation of information advantageously speeds the data entry process and reduces errors for the particular item or type of item being accepted. The list of attributes may be presented using the DEUI or other forms well known to those of ordinary skill in the art for allowing users to select multiple attributes from a list presented. For example, as data from the DEUI is entered and communicated with Data Store 3432 and associated software modules residing at the database server or client-computer, context sensitive information or questions specific to the particular seller, item for sale, or anticipated value of the item may be sent to the DEUI for the operator or customer to provide or be advised. For example, if an item such as a piece of diamond jewelry is to be sold and it is determined that the anticipated selling price exceeds a certain threshold, the Seller may be asked if a wire transfer to a bank account is an acceptable form of payment. Additionally, contextually relevant menus to be filled in may be presented, for example, in the case of a diamond, additional forms may be presented in the DEUI to query the customer or attendant if the diamond has a certified GIA Rating, the nature of the mount, etc.

As will be disclosed in further detail below, one or more embodiments of the present invention also support an ability to store arbitrary information about an item that may stream-line the processing of the item in at any stage of its processing within the Selling Service (including its selling in the online market). For example a Seller may arrive with material that should be used in the listing, such as a certificate of authenticity, an appraisal, an excerpt from a catalogue, a picture, and the like. In accordance with one or more embodiments of the present invention, such information may be added to the items entry in Data Store 3432 using a text editor, document scanner, or included with the item in the container which carries it. Information may also be entered into the DEUI to create Targeted Notes (described below).

Agreement Generation 5111: The terms for the selling arrangement between Seller and the Selling Service are captured in an agreement. In accordance with one or more embodiments of the present invention, upon the completion of Information Acquisition process 5101, a computer software program generates an agreement from a template and the Seller and item data just collected. There are several well-known techniques in the art for generating documents from templates and fields in a database or other information store. In accordance with one or more embodiments of the present invention, data in an XML format is used for generating the seller agreement form. The agreement form generated is printed in triplicate using a printer and one copy is presented to the seller for signature. The signed copy is stored for legal purposes and another copy of the agreement is placed with the item, and then, the item and the agreement are placed in a container for transportation. One of the three copies is provided to the Seller who has then completed all tasks required for using the Selling Service.

It should be understood that the foregoing has described the simplest and most straightforward manner for customer interaction involved in selling an item using the Selling Service. There are anticipated, however, many variations on this approach, for example, a Seller may be presented with average selling price data for the particular item that will sell. The Seller may request that the auction start or end at a particular time. The Seller may stipulate a minimum required selling price; the Seller may negotiate a unique commission rate for non-standard, or high-value items, the Seller may request “insurance” for an item while it is in the care of the Selling Service, the Seller may point out flaws or features unique the item being sold that should be contained in the listing of the item in a Marketplace, the Seller may request the item be listed in only one particular Marketplace, or many.

In addition, the Seller may request certain options about how the item is to be processed. Some of these options may require a fee and/or a commission prepayment. For example, the Selling Service may offer the following options to Sellers: (a) a minimum selling price, a “reserve price”, and/or undisclosed “floor price”; (b) a starting price for the bidding in an auction; (c) testing of the item; and (d) special handling of the item during processing. In addition, the following services may be offered for an additional fee: (a) an expert evaluation of authenticity or appraisal of the item; (b) a detailed testing of the item; (c) extensive testing beyond the normal testing, if any, performed; (d) special handling of the item during shipping; (e) pre-paying for shipping; (f) cleaning, reconditioning, or polishing; and (g) insurance against loss during handling or shipping.

Seller Signs Agreement 5121: As shown in FIG. 5, Seller Signs Agreement decision box 5121 determines whether an item's processing will continue. If the Seller does not sign the Agreement, the item is returned to the Seller, no further processing occurs, and the item is removed from Data Store 3432. If the Seller signs the agreement, Status Update 5151 is performed.

Status Update 5151: When the user of the DEUI presses “Accept” or “Next Item” on DEUI, the Seller and Item information is updated in Data Store 3432. Item processing then proceeds to Containment 5201.

Containment 5201: Containment 5201 is performed at Containment Station 2201 using the containment apparatus (see above). In accordance with one or more embodiments of the present invention, each item accepted for sale is placed in a container along with the accompanying signed seller agreement and any packing material deemed prudent for transportation to the Hub and storage until the item is shipped to a Buyer. All items processed by the Selling Service are associated with a database field “contained-state.” Prior to being “Contained” the item's contained-state is considered to be “pending-container” in Data Store 3432. During the containment process, the following data is recorded in Data Store 3432: the unique “Container ID” for each container in use; the unique “Item ID”, and the Hub for which the contained item is destined for processing. Once the item is contained (either “contained” or “self-contained” state) the item's destination is recorded in Data Store 3432 as the “Hub” for which the contained item is destined for processing.

For items which are too large for a standard container (for example, and without limitation, musical instruments, bicycles, and so forth), or for items which arrive in specialized manufacturers boxes (DVD players), the Containment process may consist of attaching a bar-code label to the box or item itself. This label serves the same purpose as the Container ID on the boxes or “Totes” that are used to hold most items. Such items have a data property of “Self-Contained” rather than “contained” in Data Store 3432.

Items that are composed of separable units may be placed in multiple containers. For example, in the case of an encyclopedia set, a set of twelve books comprises a single item for sale and the entire set is given a single Item ID. The set, however, may be too large or too heavy to fit into a single container, and thus the first three books may be placed in a container having Container ID 455, the second subset of three books placed in a container with Container ID 218, and so on until the last subset of books are placed in a container. The database record used to represent an item contains means for associating multiple Container ID's with a single Item ID to support the case outlined above. It should be understood that in accordance with one or more embodiments, either the Item ID or Container ID(s) for an item may be used to process the item or access the information about the item. All processing applications allow for the scanning of either the item or container barcode to identify the item.

FIG. 10 shows the User Interface used by an Inlet operator to record the Container ID(s) used to contain an item in accordance with one or more embodiments of the present invention. The Container ID is entered using a hand-held bar code scanner connected to the Process Station of Container Apparatus 3201.

The Selling Service Compute Infrastructure tracks the location of the item by tracking the container or containers in which the item or item pieces have been put. Once an item is in a container, the item's location field in Data Store 3432 is updated to “out-queue” and the item's destination field is set to the Hub associated with the Inlet. The item, or any part of the item, may be moved to different containers during the processing of the item. When items are ready to be shipped to buyers, the box in which they are packed for shipment has a unique Container ID and the item is considered “contained” by this Container ID on the shipping box. The events of a container change are entered into Data Store 3432 are tracked in Data Store 3432 continuously. This can allow, for instance, cushioned containers to be used during transportation or space-saving containers to be used during storage. FIG. 10 shows one embodiment of a Container Change User Interface that may be utilized by an operator for registering a container change.

In accordance with one or more embodiments of the present invention, all processing applications know the location of the container or containers containing the item. Applications may be written to prevent processing of an item until all of its containers are present, preventing potential partial or inaccurate processing.

Gatekeeper Station 2301 is used to perform Manifest Generation 5251 and Gatekeeper Monitoring 5301. Gatekeeper Station 2301 uses the gatekeeper load apparatus (see above).

Manifest Generation 5251: In accordance with one or more embodiments of the present invention, Contained Items 2070 remain at the Inlet to await transport to the Inlet's corresponding Hub. In accordance with one or more embodiments of the present invention, a manifest consists of a list of items to be transported. Manifest Generation process 5251 is performed at Gatekeeper Station 2201 by the gatekeeper load apparatus. FIG. 11 shows one embodiment of Gatekeeper User Interface that is fabricated in accordance with one or more embodiments of the present invention. As shown in FIG. 11, the transportation means bar-code is entered or scanned to obtain information about the transportation means from Data Store 3432. The name of the truck and the name of the operator are also entered. The “Load” and “Unload” buttons are use to indicate whether items are being correspondingly loaded into or unloaded from the transportation means. When this information has been entered, the gatekeeper load apparatus queries Data Store 3432 to find Contained Items 2070 at the location (for example, Inlet Station 2100) whose destination matches the one or more destinations of the transportation means.

In accordance with one or more embodiments of the present invention, Data Store 3432 maintains a correspondence between each item and its location. Possible location values in accordance with one or more embodiments are: (a) a particular store (each store is uniquely identified by a number); (b) in transit between store and hub; (c) a particular hub (each store is uniquely identified by a number); and (d) in the outgoing shipping section (out-queue) of the hub. At various intervals, the attendant in an Inlet, runs a program on the gatekeeper load apparatus, which causes two software processes to begin. The first process known as “Manifest Generation Process” generates a manifest for a particular destination entered by the operator from information stored in the Data Store 3432. For example, if a truck is used to transport items from the Inlet to the hub, the operator may enter “Hub” as the destination and all items whose current location is the Inlet and whose destination is the Hub would be placed on the manifest list. The second process is known as the “Gatekeeper Process” software application that makes use of the manifest to aid the attendant in transporting items in the containers in an error-free manner with accountability. The manifest contains the following information: (a) Item ID; (b) Container ID of container which holds item; (c) Inlet at which the item was accepted; and (d) Hub location at which the item should be sent for processing.

FIG. 12 shows a typical manifest and the data that is extracted from Data Store 3432 to build the manifest. It should be understood that many variations are possible for displaying the manifest, and the present invention is not limited to the example shown in FIG. 12.

Gatekeeper Processing 5301: The Gatekeeper application is comprised of a software application running on a data terminal or computer and receives as input: (a) the manifest; (b) rules or algorithms; (c) data representing the Container ID of each container presented to the Gatekeeper application; (d) information used to identify the location from which the GateKeeper application is running; (e) information used to identify the location to which containers will be transported; and (f) user input from keyboard, mouse, or speech recognition apparatus. The Gatekeeper application produces as output: (a) updates of information in Data Store 3432; and (b) user notification in the form of audible tones, or visual alerts, for example blinking LED's, computer window Pop-up dialogue boxes, and the like. The Gatekeeper application is operated at the physical location changes of the departing point and destination points for items moved between Inlets, Hub locations, expert evaluation locations, and possibly display locations. The Gatekeeper application operates in two basic modes at both Inlets locations and Hub locations: (a) monitoring departing items leaving the location (“load item monitor” mode), and (b) monitoring arriving items at a location (“unload item monitor” mode”).

In accordance with one or more embodiments, when operating in a “load item monitor” mode at an Inlet (i.e. “Load” button of FIG. 11 was selected by an operator), the program receives Container IDs from a scanner and performs a database lookup of the Container ID to obtain information and perform the following tests: (a) verify the Container ID is valid and locatable in the Selling Service Compute Infrastructure; (b) verify the location field in the database matches the location from which the GateKeeper is operating; (c) verify the item in the container or the container itself if empty, is destined for the Hub which services the Inlet; and (d) perform additional checks, such as safety checks to confirm the item can be transported via truck, airlines, and the like, or check if the item has a temperature restriction. For all containers which pass the above tests, the Gatekeeper application changes the location to the new place within the system where the container is located. For example, from “out-queue” to “truck”.

In accordance with one or more embodiments, when operating in an “unload items monitor” mode (i.e. “Unload” button was selected by an operator), the program receives Container IDs from a scanner and performs a database lookup of the Container ID to perform the following: (a) verify the Container ID is valid and locatable in the Selling Service Compute Infrastructure; (b) verify the container is destined for the location from which the GateKeeper is operating; (c) update the location field in the database to the location from which the GateKeeper is operating, or a similar entry designating the container is at a specific destination such as “incoming queue”; (d) update the destination field in the database to the location from which the Gatekeeper is operating, or a similar entry designating the container is at its final destination; and (e) perform additional checks, such as safety checks to confirm the item can be stored at the location safely, or check if the item has a temperature restriction.

If one of the tests performed in the above list fails, the Gatekeeper application produces as output an audible tone of approval or disapproval using techniques that are well known to those of ordinary skill in the art for playing tones and sounds associated with a specific action from a computer program on standard personal computers. This signal alerts the user or others performing the loading or unloading that a container has not been properly registered or transported and further investigation is needed for the container can be transported.

In accordance with one or more embodiments, audible alarms are used to allow eyes-free and hands-free confirmation that a container and the item it contains are: registered in Data Store 3432, ready for transport; and in the proper location, and will be “anticipated” at the destination. In accordance with one or more embodiments, the persons moving the containers use a laser scanner to scan bar-coded labels on each container before the items are moved from the Inlet to the transport means. Items which are flagged with a problem are not transported before further investigation to resolve the error condition.

Transportation to Hub 5398: In accordance with one or more embodiments, items are moved to trucks, other suitable vehicles, or via a parcel carrier such as United Parcel Service or the US mail, after they have been cleared from the GateKeeper application. During the “transit phase,” each item's location in the database table is marked, for example it may be marked as “truck,” in Data Store 3432. When the items arrive at the Hub, the Gatekeeper application operates in the reciprocal manner by allowing items into the Hub that are properly registered in Data Store 3432 and for which the database indicates an “in transit” status.

It should be understood that in one or more embodiments of the present invention, all scans of an item are stored as events within the system and may be reviewed at a later time. Although the foregoing process has been described in terms of a human attendant performing many of the steps disclosed, it should be understood that embodiments of the present invention are not thusly limited and many or all of the steps may be automated by machine, or performed by the Sellers themselves.

Item Processing at Hubs: The following describes how items are processed at Hubs. It should be understood that for ease of understanding, the following description pertains to a typical scenario and that embodiments of the present invention are not thusly limited.

FIG. 6 shows a flow-chart of the steps performed at a Selling Service Hub in accordance with one or more embodiments of the present invention, for example, and without limitation, Hub 1400 shown in FIG. 2. As shown in FIG. 6, many process steps read data from and/or write data to Data Store 3432. It should be understood that during processing, items move from one station to the next via a conveyer belt, platform with rollers, or other similar apparatus for moving containers from one work station to another. It should also be understood that items may be taken out of the normal processing flow, and directed to stations in a different order according to specifications in Targeted Notes or other criteria. For example, and without limitation, items may be taken out of the process flow to await the arrival of an expert appraiser, the availability of a tester or a photographer, and so forth.

Gatekeeper Processing 6311: Gatekeeper Processing 6311 occurs at Gatekeeper Station 2302 using the gatekeeper unload apparatus (see above). Contained Items 2070 from any Inlet, for example, Inlet Station 2100, arrive at Hub 1400 via various transportation means. When Contained Items 2070 arrive at Hub 1400, an operator executes the Gatekeeper software application and specifies “unload item monitor” mode by selecting the “Unload” button of the Gatekeeper User Interface shown in FIG. 11. As previously described, in accordance with one or more embodiments, items are processed by scanning the bar-coded labels on each container. The scanning may be performed by a person or a machine while container pass on a conveyer belt. Information in Data Store 3432 is read and analyzed by the gatekeeper unload apparatus. The Gatekeeper application also updates the information in the database with items new location.

Item Anticipated? 6321: The gatekeeper unload apparatus performs checks to verify that each arriving item is anticipated at Hub 1400. If an item is not anticipated, audible sounds are presented using techniques that are well known to those of ordinary skill in the art for playing sounds from a computer. The item is removed from the processing flow in order to identify and resolve any discrepancies as indicated by the terminal step of Problem Identification and Resolution 6313 in FIG. 6.

Once an item is “approved” by the Gatekeeper application, it moves to the next processing station. In accordance with one or more embodiments of the present invention, the next processing station is a Weighing Station.

Weighing 6401: Weighing 6401 is performed at Weighing Station 2401 using the weighing apparatus (see above). Containers from Gatekeeper Process 6311 move to a weighing station where the container(s) holding an item and the item it contains are weighed together. In accordance with one or more embodiments of the present invention, the weighing process is facilitated by the Weighing User Interface shown in FIG. 13. The operator scans a Container ID bar code or uses the keyboard to enter the Container ID into the Weighing User Interface. Software Modules access Data Store 3432 to determine if the Container ID entered contains one portion of a multi-contained item. If so, the Weighing User Interface indicates all Container ID's which comprise the single item. The operator then processes all those containers before processing the next item.

The item is placed on a scale, the weight of the container is subtracted using techniques that are well known to those of ordinary skill in the art, and the item's weight is recorded in Data Store 3432. In accordance with one or more embodiments, a scale factor may be added to an item's weight to account for the additional weight of the packing materials and box used for shipping. In another embodiment, a specific weight may be added to the item weight to reflect the type of box that is anticipated for shipping the item. Such information may come from information retrieved from an information store maintained at the Selling Service or a third party.

As shown in FIG. 13, the Weighing User Interface contains means for indicating that a particular items may require a large box and/or “oversized” shipping rates. Software Modules validate and record data in Data Store 3432 when the “Save” button of the Weighing User Interface is selected. In accordance with one or more embodiments of the present invention, the next processing station is the Testing station.

Item Will Be Tested 6501: Items are examined and a decision is made as to whether testing is appropriate for an item and if so what aspects or properties of the item will be tested. The operator performing this step uses the Item Testing User Interface shown in FIG. 14. The operator enters the Container ID in the Item Testing User Interface using a bar-code scanner or keyboard, and then selects whether the item should be tested. In accordance with one or more embodiments of the present invention, if the operator determines that testing will be performed the item proceeds to Testing 6551, otherwise the item proceeds to Photographing 6761. It should be understood that many criteria may be used to make a determination of whether an item will be tested, for example, and without limitation: (a) the nature of the item's imperviousness to wear, (b) the failure rate of the item; (c) demand for the item; and (d) the incremental increase in price buyers are likely to pay for a tested item.

In accordance with one or more embodiments of the present invention, a database is used to store policy information about testing for particular items or classes of items. This database is consulted for rules or algorithms to determine whether an item should be tested. The following information may be used to make the testing determination: seller input: (a) the number of similar items in process; (b) time to perform a test, (c) value of the item; (d) typical item failure rate, (e) number of functions, and (f) possibly operator input.

Testing 6551: Testing 6551 process is performed at Testing Station 2501 using the testing apparatus (see above). Items for which testing has been specified are tested. The tests performed may be determined by a number; of different means or may be unspecified. In accordance with one or more embodiments of the present invention, a list of specific tests may be stored in Data Store 3432 and presented to an operator performing the testing.

Product Specific Testing Form Generation: In accordance with one or more embodiments, Data Store 3432 maintains test form information which can be used to generate a testing template for an operator to view while testing. The test template is generated using information about the product or product class. For example, if an item is a printer manufactured from HP, the test generation software module may produce a test template which contains questions such as: (a) is a test page printed?; (b) quality of output; (c) is a toner cartridge included?; (d) memory configuration; and the like. It should be understood that the format for storing and retrieving information in the forms of questions that will be used to make a test template based on a product attribute, type or serial number is well understood by those in the art of maintaining and utilizing relational databases.

Expert Evaluation: Many items sold in the Selling Service may be antiques or collectibles requiring expertise to examine and describe them in a way that will answers questions which arise in a potential buyers mind. For example, the value of fine antique silverware may not be affected by tarnish, but could be impacted by scratches or dents. For this reason, many items will be more attractive if an evaluation from a knowledgeable expert is included in the product listing. For increased efficiency, items requiring an expert evaluator may be pulled out of the normal processing flow to wait for the an expert evaluators availability. Furthermore, the cost of an expert evaluator is reduced by having him or her fully scheduled to work in a fully utilized manner when employed by the Selling Service, typically when there are numerous items to be reviewed rather than sitting idly by waiting for a relevant item to arrive for processing. In accordance with one or more embodiments of the present invention, items may queue for expert evaluation, or be sent to locations outside the Hub.

Offsite Processing 4941: As shown in FIG. 4, items leave Hub 1400 through Item Egress 4399, and are transported to Offsite Processing 4941. Offsite Processing may include examination by an expert, verification of authenticity, or product testing. Items returning from Offsite Processing enter Hub 1400 through Item Ingress 4299.

The results of the testing process are stored in Data Store 3432. The results may affect subsequent processing including, but not limited to, whether it will continue in the normal process; how it is photographed, listed, stored, packed, and shipped; or what information is provided to the buyers. After the testing process is complete, the results are reviewed in the next step.

Results Match Seller claims 6561: In accordance with one or more embodiments of the present invention, if the test results of an item match a Seller's claims, for example, and without limitation, upon expert evaluation, an item is determined to be a counterfeit, the item is removed from the ordinary process flow and a notification is sent to Customer Service. If the results substantially match the Seller's claims, the item proceeds to Photography 6761.

Customer Service Contacts Seller 6751: When an item's test results reveal a discrepancy with the Seller's claims, Customer Service contacts the Seller to determine the disposition of the item. For example, and without limitation, the item may be mailed to Seller, picked up by the Seller, donated, or offered for sale with the test results disclosed.

Targeted Notes Processing: Many items sold in the Selling Service are not new and unused. Thus, each item can have unique flaws and/or strengths which should be noted in the final product listing for accuracy. As an example, the Seller of an item may provide unique information that is to be listed in the product description of the item. For example, a Seller with a baseball may provide information such as the fact that the baseball was from a major league game, or a home run. Furthermore, many Sellers or employees of the Selling Service may provide information important to the handling of the item, or requirements for sale such as a minimum price. In addition, the Seller may request that the auction start or end at a particular time. The Seller may stipulate a minimum required selling price; the Seller may negotiate a unique commission rate for non-standard, or high-value items, the Seller may request “insurance” for an item while it is in the care of the Selling Service, the Seller may point out flaws or features unique to the item being sold that should be contained in the listing of the item in a Marketplace, the Seller may request the item to be listed in only one particular Marketplace, or many. Once sold, the Buyer may request special handling or shipping of the item, including the possibility of picking up the item at the Hub location.

For these reasons, it is important that information related to items, their handling, and their processing be maintained as items proceed through the Selling Service and presented during the appropriate processing step. One or more embodiments of the present invention implement a method for generating notes called “Targeted Notes” which can be used to convey directions, information or requests as the item proceeds through the system. Targeted Notes are comprised of information, often containing special instructions, that are used by and for those who will be processing the item and those who support the processing of the item. Targeted Notes are used to expedite the processing and to ensure accurate and appropriate processing.

In accordance with one or more embodiments of the present invention, Targeted Notes are supported in the Selling Service Compute Infrastructure, and allow for the recording, maintenance, and viewing of information or specific instructions to be executed as the item proceeds through processing toward a Marketplace. Information may be entered at any stage of processing. The Targeted Notes are used to: (a) expedite the processing of items; and (b) to ensure accurate and appropriate processing is used by and for those who will be processing the item and those who support the processing of the item. Targeted Notes may comprise one or more of the following information: (a) information or instructions; (b) the identification of the operator creating the Targeted Note; (c) the process step being performed when the Targeted Note was created; (d) a date stamp indicating when the Targeted Note was created; (e) a list of processes during which the Targeted Note should be displayed; (f) a date stamp indication when the Targeted Note was presented or read; and (g) the identification of the operator performing a processing step when the Targeted Note was displayed.

In accordance with one or more embodiments of the present invention, such information is captured by any operator performing one or more of the steps that comprise the Selling Service process or a software module. When performed by an operator, a menu of processes is presented to the operator and the processes to which the Targeted Note pertains can be selected. At each stage of processing, software modules check for Targeted Notes pertinent to that particular stage and the Targeted Notes may be presented in a “pop-up window” with an audible cue using software techniques that are well known to those of ordinary skill in the art. These Targeted Notes may be in the form of text, picture, graphic, or audio data.

As an example of one or more embodiments, during any operation performed in the Selling Service, an operator may enter a Targeted Note to indicate the discovery of damage or extra value which is important for future processing of the item. Such information may be designated as destined for Photography step 6761 and Listing Generation step 6771 (as will be defined below). During Photography step 6761 and Listing Generation step 6771, the Targeted Note will be displayed to the person creating the listing to insure such vital information is captured in the photographs and listing generated. The original process during which the Targeted Note was created may also be displayed, for example a Targeted Note may have information which shows it was created during the “containment” process.

It should be understood that in accordance with one or more embodiments of the present invention, the Targeted Note information is written to and read from Data Store 3432, and the implementation supports multiple notes per item as well as multiple notes per process using standard database techniques well known to those in the art.

Photography 6761: Photograph 6761 is performed at Photo Station 2601 using the photo station apparatus (see above). Item listings in Marketplaces are typically accompanied by a photograph so that potential buyers may see the item they may wish to purchase. Photographs of each item are taken at various photo stations in the Hub. In accordance with one or more embodiments, each Hub contains several digital photo stations that specialize in photographing different classes of items typically categorized by size or value. For example, one photo station may be employed specifically to handle photographing small items such as jewelry, while another may be employed to photograph large items to minimize camera adjustments from item to item. The digital images are generated using cameras and software that is well known to those of ordinary skill in the art for generating and storing images on a computer. The images are written into Data Store 3432 and stored in association with the item's database record.

In accordance with one or more embodiments of the present invention, the PhotoStation User Interface shown in FIG. 15 is used by an operator to capture, photographs of an item. Using the PhotoStation User Interface, an operator enters the Container ID using a bar-code scanner or keyboard. The operator may then arrange the items appropriately for photographing. Using a digital camera, software and techniques that are well known to those of ordinary skill in the art for capturing digital photographs from a digital camera connected to a computer, the operator may “drag and drop” photographs into the any of the empty frames. When the operator is satisfied with the photographs and presses the “Save Data” button of the PhotoStation User Interface, the photographs are stored in Data Store 3432. In accordance with one or more embodiments of the present invention, the next processing step is Listing Generation.

Listing Generation 6771: Listing Generation 6771 is performed at Listing Station 2701 using the listing apparatus (see above). Item listings in Marketplaces are typically accompanied by a text description and additional information or product specifications. A typical listing consists of: (a) a photographic image of the actual product, or image of a typical product (like an album cover artwork); (b) a textual description of the item; (c) a textual description of the media work the item may contain; (d) attributes of the product such as damage, operational status, and any tests preformed and the corresponding test results; and (e) Information about the selling of the item, for example a shipping requirements, a minimum price, a Buy It Now price which can paid to immediately purchase an item and close the auction for the item, and the like.

As shown in FIG. 6, the output of the Listing Generation 6771 process is Listing 6775 which is stored in the Selling Service Compute Infrastructure and later verified during the “Listing Verification” step (described below).

In accordance with one or more embodiments of the present invention, operators performing the Listing Generation process are aided by the Listing Generation Edit-View User Interface shown in FIG. 16, the Listing Generation Images-View User Interface shown in FIG. 17, and the Listing Generation Preview-View User Interface shown in FIG. 18, FIG. 19, FIG. 20, FIG. 21, FIG. 22, and FIG. 23.

As shown In FIG. 16, operators enter a Container ID using a bar-code scanner or keyboard. Editable Text-Boxes are used for each of the “Description,” “Features,” “Accessories,” and “Comments” sections of the Listing. These Text Boxes can be toggled individually to display either the text or the HTML used to generate the formatted text of the listing.

Additional information such as the age of the item, and Title listing is entered using the Listing Generation Edit-View User Interface.

As shown in FIG. 17, the Listing Generation Images-View User Interface displays the list of photographs associated with the item. An operator may rearrange or delete photographs using the user interface in a manner that is well known to those of ordinary skill in the art of using computer interfaces.

As shown in FIG. 18, FIG. 19, FIG. 20, FIG. 21, FIG. 22, and FIG. 23, the Listing Generation Preview-View User Interface displays the listing as it will appear on one or more Marketplaces.

When the operator is satisfied with the listing they have generated, the listing is saved using the “File→Save” menu and the Listing is stored in Data Store 3432.

In accordance with one or more embodiments of the present invention, the item proceeds to Store, Display, Pack 6901 process to await the outcome of the items participation in the Marketplace. For ease of understanding item processing, the Listing processes and participation in a Marketplace will be described later.

Storage, Display, Pack 6901: In accordance with one or more embodiments, a typical item proceeds to a storage location after the listing has been generated. Although there are many variations, as to how and when items are stored, the following steps are usually performed: (a) Store; (b) Pick, (c) Pack, and (d) Ship. FIG. 8 shows the possible processing orders that may be employed as an item participates, and is possibly sold, in a Marketplace. As shown in FIG. 8, an item may be processed via path 8910 in the event the item is sold before reaching Storage Area 2900. Alternatively, an item may be processed via path 8911 in the event the item is packed for shipment before being stored. In yet another alternative, an item may be processed via path 8912. In still yet another alternative, an item may be displayed at a location and processed via path 8913.

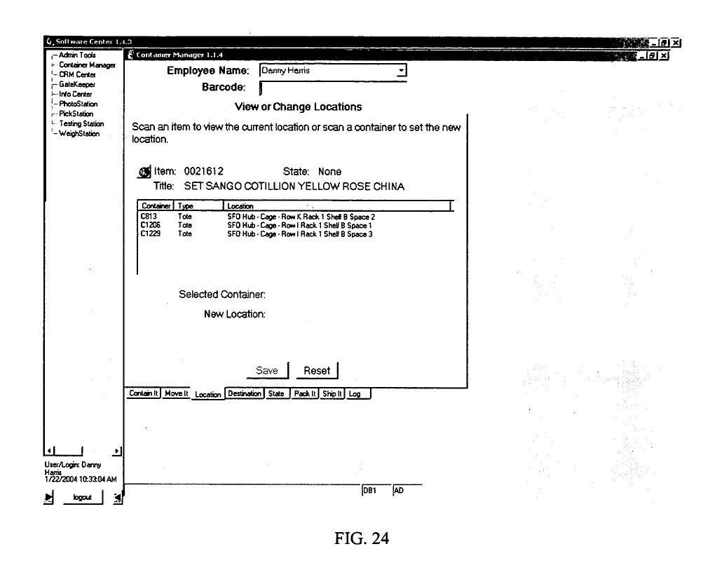

Storage 8901: The container containing an item is moved to storage location. In accordance with one or more embodiments, modular containers are placed on racks of shelves with a specific location code under each location. The location code uses a format similar to the of the Container ID, and contains a bar code and human-readable alphanumeric code. In accordance with one or more embodiments of the present invention, the operator performing the this step uses the Container Location User Interface shown in FIG. 24 to record the location of the container during storage. In accordance with one or more embodiments, the operator scans the container using a bar-code scanner and the bar-code label indicating the storage location (for example, and without limitation, row and shelf identifiers in a warehouse). In accordance with one or more embodiments of the present invention, a wireless computer network and portable computer or PDA is used to capture the Container ID information and the location information using techniques that are well known to those of ordinary skill in the art for example, and without limitation, using processing station apparatus 3455 of FIG. 3. Items remain in storage until they are needed. In accordance with one or more embodiments of the present invention, items are retrieved using a Pick process.

Pick 8921: In accordance with one or more embodiments of the present invention, a list of all items that have the status “Sold/Not_Shipped” is produced and used to guide the retrieval of items from the storage facility. The following steps are performed: (a) the item's location in the storage facility is noted and reported to an operator; and (b) the item is retrieved and placed on a conveyer belt or wheeled platform where it proceeds to the packing process. In accordance with one or more embodiments of the present invention, the operator utilizes the Pick Station User Interface shown in FIG. 30 to aid in the location of the items to be sent to the packing process. As shown in FIG. 30, in accordance with the Pick Station User Interface, information about each item to be “picked” from the Selling Service is displayed along with information about the item's containment and location. The operator checks off items by scanning their Container IDs and placing the item at their destination, for example, and without limitation, the shipping station.

It should be understood that there are many methods well known to those of ordinary skill in the art for automatically selecting items from storage and placing them on a new location such as conveyer belt or cart. Such machines may be employed by one or more embodiments of the present invention.

Display 8972: Items may be transported to locations within an Inlet, a Hub, or other locations for display. The display of items may be used to generate more business, or to showcase unique items submitted to the Selling Service. As shown in FIG. 8, items destined for display are packed appropriately, transported to display locations, and then unpacked. The items are then “displayed” or showcased until they are sold, or their participation period in a market completes without a sale, or a predetermined amount of time elapses. Then, upon the occurrence of such an event, the item is packed appropriately, transported to the Hub, and then unpacked and placed in a container or possibly kept in the same container for all further processing in the Hub. It should be noted that in accordance with one or more embodiments of the present invention, all items leaving Selling Service Hub 1400 do so by passing through Gatekeeper 4301 and Item Egress 4399, and re-enter Selling Service Hub 1400 through Item Ingress 4299 and Gatekeeper 4300.

Pack 8960: During the pack process, items enter a packing location in containers. The bar-code label on the container is scanned to obtain the Container ID. Then items are removed from their containers and packing occurs. In accordance with one or more embodiments, various packing materials and boxes are available and appropriate material and boxes are used to insure the items will not be damaged during shipment to the buyer. After items have been packed, the boxes are sealed and an operator utilizes the Pack User Interface shown in FIG. 31 to create Box Ids for each box that carried an item or portion of an item. In accordance with one or more embodiments, labels containing bar-coded Box Ids and corresponding human-readable alphanumerics are printed using a laser printer and affixed to the boxes.

In accordance with one or more embodiments of the present invention, packing of all items takes place at stations dedicated for packing items. Each Hub may contain several packing stations that are dedicated to packing different sorts of items. For example, and without limitation, one packing station may be used solely for printed, bound materials such as books. This station would have appropriate sized boxes and packing material specifically designed for the safe transport of printed, bound materials, typically small boxes and plastic air bladders. Another station may be dedicated to the packing of large items, such as bicycles that require bubble wrap and large boxes. A single packing station may serve for the shipping of all items.

FIG. 8 shows alternative process flows for items that can occur in the “Storage, Display, Pack” process of FIG. 6. For example, if an item is sold in a Marketplace before it reaches the storage step, the item is processed using the Pack and Ship steps of path 8910 shown in FIG. 8. If the item has not been sold before reaching the storage step, but does sell, then the item may undergo processing of the Store, Pick, Pack, and Ship steps of path 8912 shown in FIG. 8. Alternatively, some items may be packed before storage, and undergo processing of the Pack, Store, Pick, and Ship steps of path 8911 of FIG. 8. Lastly, if an item is to be displayed, it may undergo processing of the Display, “Pack Transport Unpack”, Display, “Pack Transport Unpack” steps of path 8913 of FIG. 8, and then re-enters the “Storage, Display, Pack” processing steps at input point 8902 of FIG. 8.

Ship 8981: During Shipping, a box containing an item is given a container id in the form of a bar-coded label. The operator uses the Ship It User Interface shown in FIG. 32 to retrieve information about the shipping of an item. The item's container id is entered using the bar-code scanner or keyboard and a container id is generated for each box used to ship the item or its constituent components.

The item is submitted to a shipping carrier with the required information using techniques that are well known to those of ordinary skill in the art for communicating to a shipping service, such as United Parcel Service (UPS) that an item is ready for shipment.

Gatekeeper Registration 8309: In accordance with one or more embodiments of the present invention, after items are shipped, they are processed by Gatekeeper Registration 8309 which operates in the manner described for Gatekeeper Station 2301. It should be noted that the container id used to identify the item is now the number given to the box in which the item is shipped.

Listing Processing and Participation in a Marketplace: As described above, a listing is data that acts as a proxy for an item in one or more Marketplaces. An informative listing obviates the need for a Buyer to inspect or handle an item before purchasing it.

It should be understood that after Listing Generation 6771, the item for sale proceeds to the “Storage, Display, Pack” 6901 process shown in FIG. 6. The processing of an item in Storage, Display, Pack 6901 is dependent upon on events in a Marketplace. The next sections describe the listing process and participation in a Marketplace in temporal order. It should be understood that processing of an item's listing and the item's participation in a Marketplace occur in parallel with processing of the item in the “Storage, Display, Pack” process step 6901. Furthermore, it should be understood that the processing performed on an item in the “Storage, Display, Pack” process step 6901 is contingent on the outcome of participating in the MarketPlace.

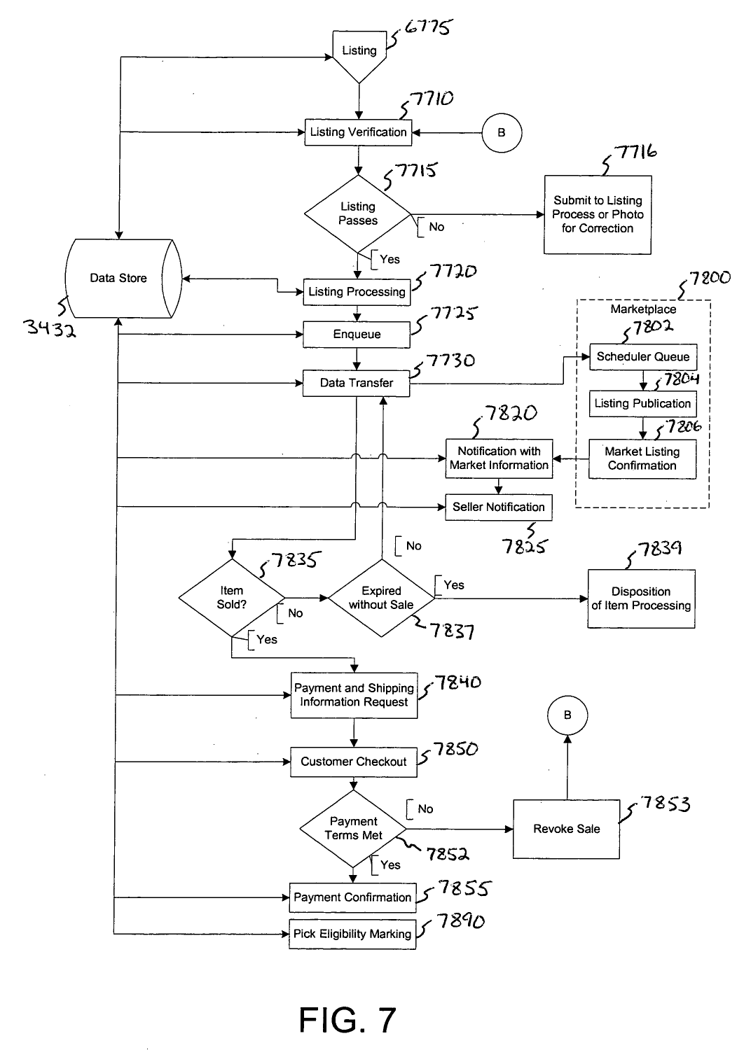

Listing Verification 7710: In accordance with one or more embodiments of the present invention, the listing for each item is verified before being submitted to a Marketplace. As shown in FIG. 6, each item enters “Listing Generation” 7710 step. This step produces a representation of the item for use in a Marketplace known as a “listing.” As shown in FIG. 7, each listing undergoes verification and quality checks. The verification may consist of both manual and automated checks. For example, in accordance with one or more embodiments, one or more of the following automated checks are performed: (a) spelling and grammar checks of one or more text portions of the listing; (b) a syntax check of the display control language (for example, a syntax check of the HTML in the listing); (c) the format and size of images are checked to determine whether they are within specified parameters and conform with various requirements of Marketplaces; and (d) a check that the number of images conforms with various requirements of Marketplaces.

In addition, the following manual checks may be performed: (a) a check to determine whether the appearance is consistent with a Selling Service “brand”; (b) a check to determine whether the amount of information is appropriate for the item; (c) a check to determine whether the information is accurate; (d) a check to determine whether the photographs are clear and items are visible; and (e) a check to determine whether the correct template is used.

As shown in FIG. 7, after all checks are performed, the listing proceeds to decision process Listing Passes 7715.

Listing Passes 7715: As shown in FIG. 7, after all checks are performed, decision block Listing Passes 7715 determines whether the listing is suitable for submission to a Marketplace. If the listing is determined to be unsuitable, the listing is submitted to Submit to Listing Process or Photo for Correction 7716, and further processing ceases until the listing is corrected. If the Listing is suitable for submission to a Marketplace, control transfers to Enqueue 7725.

Submit to Listing Process or Photo for Correction 7716: This process routes the listing to the appropriate processing step for correction. In accordance with one or more, embodiments of the present invention, the manual checks may indicate changes are required, and in accordance with one or more embodiments, changes to the final listing are made using a What You See Is What You Get (WYSIWYG) editor using techniques that are well known to those of ordinary skill in the art. After correction, the listing is submitted to Listing Verification 7710.

Listing Processing 7720: As shown in FIG. 7, listings which pass Listing Verification 7710 are processed according to the requirements for submission to one or more Marketplaces. In accordance with one or more embodiments of the present invention, Software Modules which manage the submission process of a listing mark listings which have been processed with data indicating they are ready for submission. Other software processes scan the database records for the listing and may perform additional steps such as data compression, or programmatic modifications (for example, and without limitation, determining the correct category within a Marketplace to list the item and specifying such information in the appropriate location) to a predefined data structure for submitting the listing using an API or similar programmatic interface.

It should be noted that in accordance with one or more embodiments of the present invention, the posting process is managed to optimize the price obtained for an item by considering such factors as: (a) which of several Marketplaces the item will be “listed on”; (b) the time of day the auction will end; (c) the day on which the auction will end; (d) the number of similar items currently offered on a particular Marketplace; (e) the number of items in queue, in process, or expected at the Selling Service; (f) the market trend of pricing for an item (is it becoming more or less valuable as time passes); and (g) the behavior of previous auctions of similar items. In accordance with one or more embodiments of the present invention, Software Modules may use rules, heuristics, and current information from the Marketplace to determine the proper time to publish the listing in the Marketplace and what pricing structures, for example, and without limitation, Buy It Now prices, would be meet various criteria of the Seller and Selling Service.

Maximizing the final sale price maximizes the commission paid to the Selling Service in accordance with one or more embodiments.

Enqueue 7725: As shown in FIG. 7, listings which have been processed and marked ready for submission using techniques that are well known to those of ordinary skill in the art for managing data in a database, are identified and enqueued for submission to a Marketplace. The process of enqueuing the item is accomplished in Data Store 3432 by adding the item listing to a queue of listings that will be submitted to the Marketplace. Listings remain in the queue until transferred to the appropriate API or data transfer interface at the Marketplace. It should be understood that any of several methods may be used to transfer the data and the invention is not limited to any one particular method. For example, and without limitation, the Internet may be used to transfer data to an interface at the Marketplace, information may be submitted by faxing a form to the Marketplace, an email may be sent to communicate the information, or a phone call may be placed to communicate the information. In accordance with one or more embodiments of the present invention, a Marketplace is eBay.

Data Transfer 7730: In accordance with one or more embodiments of the present invention, the transfer of data between a Selling Service and a Marketplace is accomplished by exchanging data at intervals. During this process, Software Modules use techniques that are well known to those of ordinary skill in the art to initiate data transfers: uploading information read from Data Store 3432 and downloading information which is processed or written into Data Store 3432. Among the data typically downloaded is information indicating which items have sold in Marketplace 7800. The Selling Service then uploads information such as new listings to the appropriate software interface or directory in Marketplace 7800.

Marketplace 7800: As shown in FIG. 7, the following steps occur outside the Selling Service in MarketPlace 7800: Scheduler Queue 7820; Listing Publish 7804, and Marketplace Listing Confirmation 7806.

Scheduler Queue 7802: As shown in FIG. 7, Scheduler Queue 7802 is part of MarketPlace 7800. Scheduler Queue 7802 receives a listing and a date and time at which the listing should be activated or published on Marketplace 7800. Software Modules or other agents contained in Marketplace 7800 endeavor to publish listing at the specified times.

Listing Publication 7804: As shown in FIG. 7, Listing Publication 7804 performs the act of publishing the listing. The manner of publishing depends on Marketplace 7800.

Marketplace Listing Confirmation 7806: As shown in FIG. 7, Marketplace Listing Confirmation 7806 provides an indication to Notification with Market Information 7820 that a particular listing has been published on Marketplace 7800.

Notification with Market Information 7820: As shown in FIG. 7, Notification with Market Information 7820 receives an indication from Marketplace 7800 that a particular listing has been published. In accordance with one or more embodiments of the present invention, this notification is in the form of an email message. In response, Software Modules parse the email message and update information regarding the listing and corresponding item in Data Store 3432. Control then transfers to Seller Notification 7825.

Seller Notification 7825: In accordance with one or more embodiments of the present invention, when notification of an items being listed is received by Notification with Market Information 7820, Software Modules generate a notification in the form of an email which is sent to the item's Seller's email address. The email created typically includes information in the form of a HyperText Mark-up Language (HTML) link which the Seller can use to view the actual listing on Marketplace 7800. Additional information such as the duration the listing will be available in Marketplace 7800 may be included.

Item Sold? 7835: After each information transfer or at regular intervals, it is determined whether or not an item has sold. As shown in FIG. 7, if the item has not sold, control transfers to Expired without Sale 7837. If the item did sell, control transfers to Payment and Shipping Information Request 7840.

Expired without Sale 7837: As shown in FIG. 7, in the event an item does not sell during the period its listing is active on the Marketplace, a notice of expiration is given by the Marketplace. In this case, control transfers to Process Disposition of Item 7839. If a notice of expiration has not been received, control transfers to Data Transfer 7730.

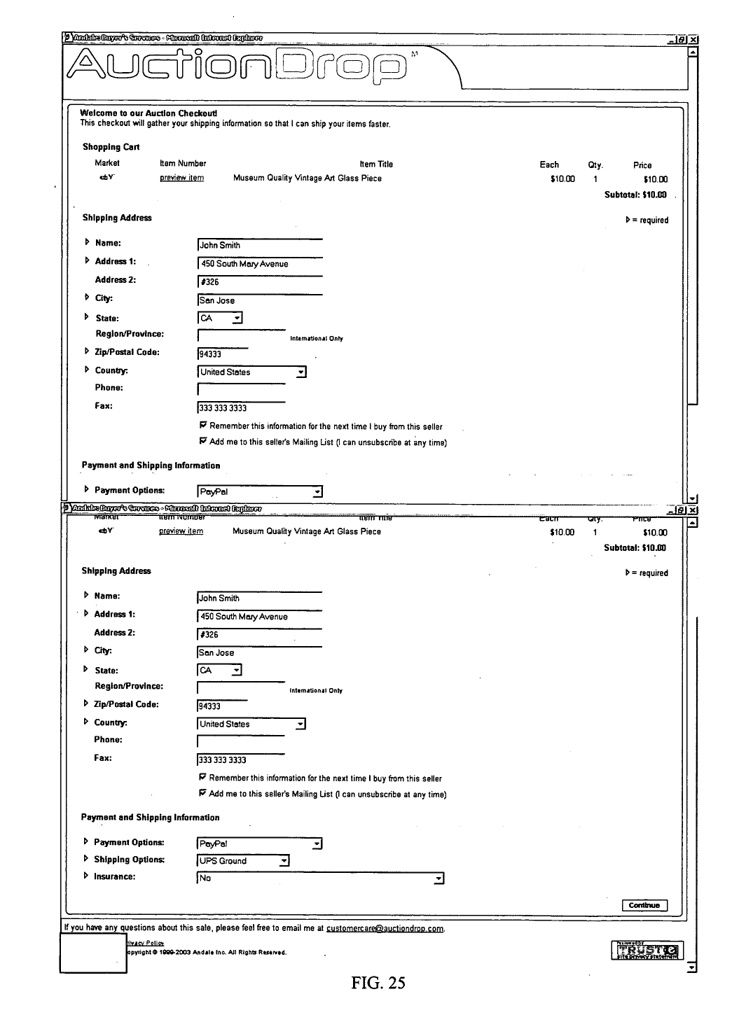

Payment and Shipping Information Request 7840: As shown in FIG. 7, when an item is sold on Marketplace 7800, this process is invoked to parse the information regarding the Buyer and the price paid—as provided by Marketplace 7800. This information is used by Software Modules to generate an email message to the Buyer requesting the shipping method desired and how the Buyer wishes to make payment for the item purchased. In accordance with one or more embodiments of the present invention, the email contains an HTML link to web page with the Customer Checkout User Interface shown in FIG. 25. Control then transfers to Customer Checkout 7850.

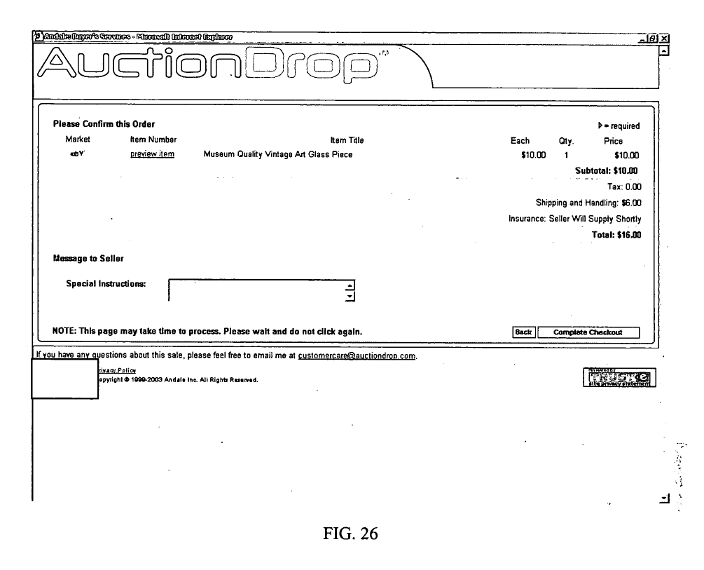

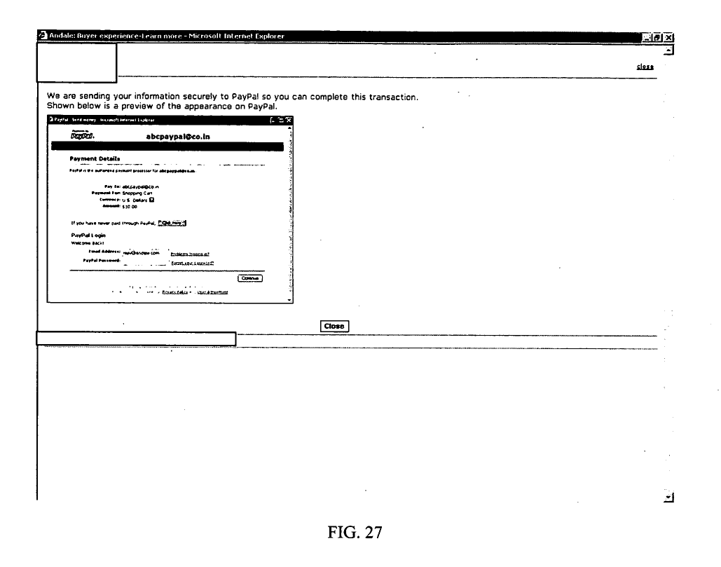

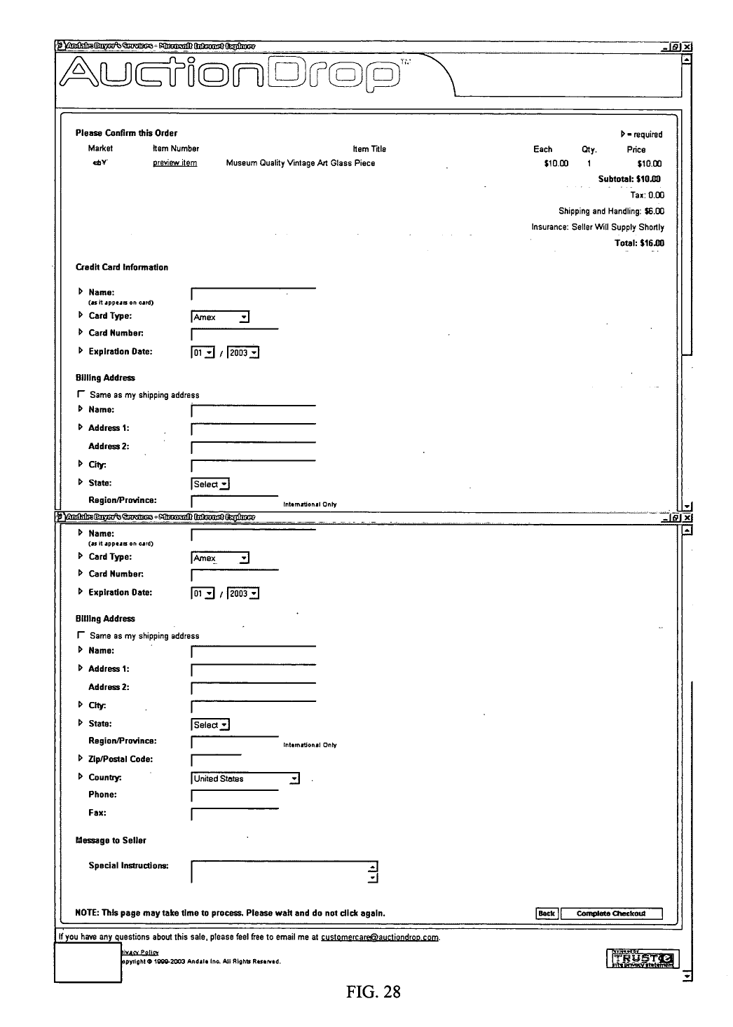

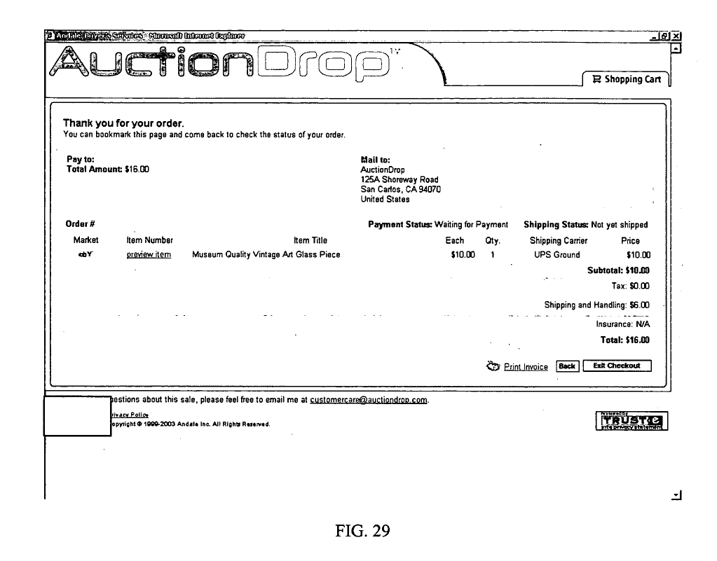

Customer Checkout 7850: In accordance with one or more embodiments of the present invention, Buyers who purchase items listed by the Selling Service on Marketplace 7800 receive an email message created by Software Modules in Payment and Shipping Information Request 7840. When a Buyer clicks on the link, he/she is directed to a web page that displays the Customer Checkout User Interface shown in FIG. 25. As shown in FIG. 25, the Buyer provides shipping information and such information is stored in Data Store 3432 using techniques that are well known to those of ordinary skill in the art for processing and storing data from a web-page form. It should be noted that the shipping information is required to determine shipping costs which must be determined before a total price can be calculated. FIG. 26 shows the Customer Confirm Purchase User Interface that is invoked when the Buyer selects PayPal as the payment method. Software Modules in the Selling Service Compute Infrastructure process and commit the sale by billing the specified PayPal account when the Buyer presses “Complete Checkout” button of the Confirm Purchase User Interface. FIG. 27 shows a PayPal Payment Confirmation Page that is displayed after the Buyer completes the payment process using PayPal. If the Buyer selected the “Pay by Credit Card Option,” the Customer Credit Card Purchase User Interface shown in FIG. 28 is presented to the Buyer to collect the credit-card information. FIG. 29 shows the Customer Confirm Credit Card Purchase User Interface that is invoked when the Buyer selects a credit card as the payment method. Software Modules in the Selling Service Compute Infrastructure process and commit the sale by billing the credit card account specified when the Buyer presses “Complete Checkout” button of the Confirm Purchase User Interface.

Payment Confirmed 7855: In accordance with one or more embodiments of the present invention, a notification is sent when the Buyer has paid for the item and its shipping. Upon receipt of this information, Software Modules in the Selling Service Compute Infrastructure are employed to perform the following: (a) verify payment has been received for an item; (b) update the items status to “SOLD/NOT SHIPPED”; and (c) notify the Seller (according to the Seller's preference or the current procedures in place at the Selling Service). After these processes have been completed control transfers to Item Pick Eligible 7890.

Payment Terms Met 7852: If payment terms are not met, for example and without limitation, payment is not received within a predetermined time period from the purchase event in the Marketplace, the sale will be revoked and control will transfer to Revoke Sale 7853. If the payment terms are met, control is transferred to Payment Confirmation 7855.

Revoke Sale 7853: In accordance with one or more embodiments of the present invention, sales are revoked if payment terms are not met. Software Modules performing the processing of Revoke Sale 7853 perform the necessary database updates to enable the item listing to be published in one or more Marketplaces as indicated by transfer of control to Listing Verification 7710.

Item Pick Eligible 7890: The process of marking an item with “Sold/Not Shipped” in Payment Confirmed 7855 makes that item eligible for Packing and Shipping. In accordance with one or more embodiments of the present invention, the item that has been purchased may have already been processed by one or more steps of the paths shown in FIG. 8.

In addition to the description above, in accordance with one or more further embodiments of the present invention, the Selling Service Compute Infrastructure may include procedures wherein: (a) different types of items may be processed using different sequences of processing events; (b) different items may be processed using sequences of processes steps that are different based on predetermined criteria (for example, predetermine process scripts) so that there is an overall cost savings and efficiency of Hub resources; and (c) different items may be processed according to priorities using sequences of process steps that are different for different priorities so that work flow steps may be optimized to reflect resources such as staffing or machine availability, for example, and without limitation, this may enable expertise which is available only from certain resources which have limited availability, to inspect and/or process items of a particular type at a given time. In accordance with one or more embodiments of the present invention, this functionality is provided by data input to Data Store 3432, which data input is used to control process flow by specifying data such as, the next processing step to perform, the time to perform the step, and so forth. Advantageously, such embodiments of the present invention provide the capability to load-balance critical resources through intelligent scheduling of resource utilization.

In accordance with one or more embodiments of the present invention, processes that are time-intensive may be replicated so that the duration of item processing is reduced by removing bottlenecks. For example, if the step of photographing an item takes twice as long as the step of creating a listing for an item, multiple photography stations may be employed. In addition, multiple photography stations may be set up for any number of reasons: for example and without limitation, stations may be set up to minimize adjustments from item to item—one photography station may be used to handle photographing small items such as jewelry, while another may be used to photograph large items.

In accordance with one or more embodiments of the present invention, the following methods may be used to entice Sellers and potential Sellers to utilize the Selling Service. For example, computer monitors at an Inlet may display items currently being sold, and/or information about the average selling prices of particular items. In addition, photographs or posters of unique items sold through the Selling Service may be used to demonstrate the efficacy thereof. In addition, compensation to Sellers may include be a percentage of the selling price, a flat fee, and so forth to be paid before the listing, before a sale has been made, and so forth.

In most cases, items are unaltered after they are brought to an Inlet to be sold, however, in accordance with one or more further embodiments of the present invention, items may be repaired, restored, split into portions for sale as separate items, and multiple items combined and offered for sale as a single item according to Selling Service policies or other criteria (for example, to maximize selling price or other criteria).

Although embodiments of the current invention described above utilized bar-coded labels and laser scanners to read the bar-codes, it should be understood that embodiments of the present invention are not thusly limited, and it is contemplated that other means can be used for identifying items, for example, and without limitation, wireless ID chips which communicate information when in the presence of a transmitter/receiver apparatus using techniques that are well known to those of ordinary skill in the art.

Those skilled in the art will recognize that the foregoing description has been presented for the sake of illustration and description only. As such, it is not intended to be exhaustive or to limit the invention to the precise form disclosed. For example, although one or more embodiments of the present invention have been described in terms of an interaction with an online Marketplace having a capability for electronic data transfers, embodiments of the present invention are not thusly limited. In particular, embodiments of the present invention can be utilized with any type of Marketplace, from fully automated Marketplaces to Marketplaces having no automation. In addition, although items were described above as tangible objects, it should be understood that items can also be intangibles objects such as, for example and without limitation, services.

What is claimed is:

1. A selling service that comprises:
accepting items to be sold from sellers at one or more inlets;
generating data regarding the items by evaluating the items and photographing the items;
formulating listings for the items by preparing text and combining the text with results of the evaluations and photographs, which listings include one or more sales criteria;
transmitting the listings to a marketplace;
receiving notifications of sales, including buyers' identities;
receiving payments from the buyers; and
sending items purchased to the buyers.

2. The selling service of claim 1 wherein the step of generating data includes entering the results of the evaluations and the photographs into a database.

3. The selling service of claim 2 wherein the step of transmitting the listings to a marketplace includes sending the listings over the Internet.

4. The selling service of claim 2 wherein the step of receiving notifications of sales includes receiving notifications over the Internet.
